(19) United States
(12) Patent Application Publication
(10) Pub. No.: US 2014/0087284 A1
(43) Pub. Date: Mar. 27, 2014

(54) DIRECT OXIDATION FUEL CELL AND METHOD FOR PRODUCING CATALYST-COATED MEMBRANE USED THEREFOR

(71) Applicant: Hideyuki Ueda, Osaka (JP)

(72) Inventor: Hideyuki Ueda, Osaka (JP)

(73) Assignee: PANASONIC CORPORATION, Osaka (JP)

(21) Appl. No.: 13/980,026

(22) PCT Filed: Oct. 11, 2012
(86) PCT No.: PCT/JP2012/006511

§ 371 Date: Jul. 16, 2013

(30) Foreign Application Priority Data
Dec. 1, 2011 (JP) 2011-263301

(51) Int. Cl. H01M 8/10

(52) U.S. Cl. CPC H01M 8/1055
USPC 429/444

(57) ABSTRACT

A direct oxidation fuel cell with high catalyst utilization efficiency and excellent power generation characteristics. The unit cell includes: a membrane-electrode assembly including an anode, a cathode, and an electrolyte membrane interposed therebetween; and anode-side and cathode-side separators being in contact with the anode and cathode, respectively. The anode and cathode each includes a catalyst layer disposed on one principal surface of the electrolyte membrane. At least one of the anode and cathode catalyst layers has a center portion and a peripheral portion surrounding the center portion. The catalyst amounts C_{2b} and C_{2c} per unit projected area of regions facing the midstream and downstream of the flow channel of the separator within the peripheral portion are each smaller than the catalyst amount C₁ per unit projected area of the center portion.

### TECHNICAL FIELD

The present invention relates to a direct oxidation fuel cell, and specifically to an improvement of a catalyst layer of a direct oxidation fuel cell.

### BACKGROUND ART

Energy systems using fuel cells have been proposed as means for solving the environmental problems such as global warming and air pollution and the problems of depletion of resources so that a sustainable recycling society can be realized.

Examples of fuel cells include stationary fuel cells installed in factories, houses, etc., and non-stationary fuel cells used as a power source for automobiles, portable electronic devices, etc. As compared with power generators employing gasoline engines, fuel cells are quiet in operation and emit less exhaust gas which causes air pollution. Therefore, in recent years, for use as a portable power source to be used in construction sites, for outdoor leisure use, in case of emergency and disaster, in medical situations, in filming locations, etc., fuel cells are expected to be put into practical use as early as possible.

There are various fuel cells depending on the type of electrolyte to be used. Among them, special attention is paid on polymer electrolyte fuel cells (PEFCs) because of their low operation temperature and high output density.

Some PEFCs use hydrogen as a fuel, and some use a fuel being liquid at room temperature. The latter are called direct oxidation fuel cells (DOFCs). Generating electric energy by directly oxidizing the fuel, DOFCs require no reformer, and can simplify the fuel cell system. Among them, DOFCs that generate power by directly supplying an organic fuel such as methanol or dimethyl ether to the anode and oxidizing the fuel are attracting attention, and being actively researched and developed. Such DOFCs are advantageous not only because they can simplify the fuel cell system, but also because they use an organic fuel, which has a high theoretical energy density and is easy to store.

PEFCs have a unit cell comprising a membrane-electrode assembly (hereinafter referred to as “MEA”) sandwiched between separators. In general, the MEA includes a polymer electrolyte membrane, and an anode and a cathode arranged on both sides thereof. The anode and cathode each include a catalyst layer and a diffusion layer. The catalyst layer of the anode is bonded to one principal surface of the polymer electrolyte membrane, and to the other principal surface thereof, the catalyst layer of the cathode is bonded. The polymer electrolyte membrane and the anode and cathode catalyst layers formed on both principal surfaces thereof constitute a catalyst-coated membrane (CCM). The anode and cathode catalyst layers generally include, as a catalyst, platinum (Pt), a platinum-ruthenium (Pt—Ru) alloy, or the like.

PEFCs generate power by supplying a fuel to the anode, and supplying an oxidant (e.g. oxygen gas or air) to the cathode. In direct methanol fuel cells (DMFCs) using methanol as a fuel, methanol and water are supplied to the anode.

For example, the electrode reactions in DMFCs are as follows.

Anode: CH₃OH+H₂O→CO₂+6H⁺+6e⁻

Cathode: 3/2O₂+6H⁺+6e⁻→3H₂O

At the anode, methanol reacts with water to produce carbon dioxide, protons, and electrons. The protons produced at the anode pass through the electrolyte membrane and reach the cathode, while the electrons reach the cathode via an external circuit. At the cathode, oxygen reacts with the protons and electrons to produce water.

In PEFCs, fuel and oxidant are each supplied via a supply port into a flow channel formed along the plane of the catalyst layer. As they pass through the flow channel and away from the supply port, the pressure thereof in the flow channel and the compositions of their components vary. As such, it is difficult to allow the reaction to proceed uniformly and stably throughout the entire catalyst layer. If the reaction does not proceed uniformly, the power generation efficiency is lowered.

Under these circumstances, for the purpose, for example, of allowing the electrode reaction to proceed uniformly as much as possible, various studies have been made to adjust the distribution of the amount of catalyst in the cathode layer.

For example, Patent Literature 1 discloses that in the catalyst layer of a PEFC using hydrogen as a fuel, the amount of catalyst in the peripheral region surrounding the center region is set smaller than that in the center region. By controlling the amount of catalyst as above, Patent Literature 1 intends to control the electrochemical activity in the peripheral region, thereby to suppress the occurrence of pin holes, the occurrence of cracks and separation of the catalyst layer, and the like.

Patent Literature 2 discloses that, in order to make the power generation less concentrated upstream of the flow channel of reaction gas (hydrogen gas) so that power can be generated uniformly, the amount of catalyst contained at a portion facing the upstream of the flow channel is set smaller than that facing the downstream. Patent Literature 2 teaches that by achieving uniform power generation, the power generation efficiency can be enhanced.

Patent Literature 3 discloses that in a PEFC using hydrogen as a fuel, by setting the amount of catalyst such that it decreases with distance away from the edge of the rib of the separator in the in-plane direction of the cell (i.e., setting the amount of catalyst smaller at a portion where the amount of power generated is small), so that the catalyst that does not contribute to power generation can be reduced. Conversely, by setting the amount of catalyst larger at a portion where the amount of power generated is small, the reduction in the amount of power generated at this portion can be prevented.

### CITATION LIST

### Patent Literature

[PTL 1] Japanese Laid-Open Patent Publication No. 2010-251331
[PTL 2] Japanese Laid-Open Patent Publication No. 2005-44797
[PTL 3] Japanese Laid-Open Patent Publication No. 2007-242415

### SUMMARY OF INVENTION

### Technical Problem

Pt used as a catalyst in the catalyst layer of a PEFC is a very expensive noble metal. If the amount thereof used is large, the production cost of the fuel cell cannot be reduced. In PEFCs using hydrogen as a fuel as disclosed in Patent Literatures 1 to 3, the oxidation speed of hydrogen gas is fast, and accordingly, the amount of Pt used as a catalyst is comparatively small.

In DMFCs, (1) the oxidation speed of methanol is slow, and the anode overvoltage is high, and (2) due to methanol crossover (hereinafter shortly referred to as “MCO”), i.e., a phenomenon in which methanol passes in an unreacted state through the electrolyte membrane, the oxygen reduction reaction and the methanol oxidation reaction occur simultaneously at the cathode, and the cathode potential decreases. For the above reasons and others, the power density is considerably reduced. As a countermeasure therefor, DMFCs use a large amount of catalyst, as compared with PEFCs employing hydrogen as a fuel: it is about 10 to 50 times as large as that in the PEFCs in the anode catalyst layer, and about 3 to 6 times as large as that in the PEFCs in the cathode catalyst layer. The catalyst effective surface area (reaction site) in the catalyst layer is thus increased.

As such, in DMFCs, if the electrode reaction does not occur uniformly, the amount of unreacted catalyst to remain unused for the reaction is much larger than that in PEFCs using hydrogen as a fuel. In short, in DMFCs, as compared with PEFCs using hydrogen as a fuel, the catalyst utilization efficiency is difficult to improve.

By using a smaller amount of catalyst, the absolute amount of unreacted catalyst can be reduced, but on the other hand, the power generation characteristics are degraded, failing to maintain a high power density over a long period of time. It has been difficult, therefore, to improve both the catalyst utilization efficiency and the power generation characteristics.

The catalyst layer is directly formed on the electrolyte membrane, or is formed on another substrate and then heat-transferred onto the electrolyte membrane, or is formed on the diffusion layer and then heat-bonded to the electrolyte membrane. The method of directly forming a catalyst layer on the electrolyte membrane is popular in recent years, because this can ensure the interface bonding between the electrolyte membrane and the catalyst layer, and can reduce the thermal damage and mechanical damage to the electrolyte membrane.

The catalyst layer can be directly formed on the electrolyte membrane by, for example, spray coating method, die coating method, or roll transfer method. Among them, according to spray coating method, since a catalyst layer can be formed by depositing or stacking a catalyst ink little by little on the electrolyte membrane, the resultant catalyst layer is unlikely to have cracks (breaks). Therefore, a catalyst layer excellent in proton conductivity and diffusibility of fuel and oxidant can be formed.

However, in spray coating method, in order to form a catalyst layer on a predetermined region on the electrolyte membrane, a mask is placed around the predetermined region, to adjust an area to be coated. For forming a uniform catalyst layer, a catalyst ink should generally be sprayed to every corner of the predetermined region, and therefore, a large amount of catalyst ink will be deposited also on the mask. The catalyst ink deposited on the mask leads to a material loss in the coating process, which increases the production cost of the catalyst layer.

### Solution to Problem

The present invention intends to provide a direct oxidation fuel cell in which the amount of catalyst used is reduced, while the catalyst utilization efficiency as well as the power generation characteristics can be improved, and a method for producing a catalyst-coated membrane used for the direct oxidation fuel cell.

One aspect of the present invention relates to a direct oxidation fuel cell having at least one unit cell. The unit cell includes: a membrane-electrode assembly including an anode, a cathode, and an electrolyte membrane interposed between the anode and the cathode; an anode-side separator being in contact with the anode; and a cathode-side separator being in contact with the cathode.

The anode-side separator has a supply port for supplying fuel therethrough, and a fuel flow channel extending from the supply port.

The cathode-side separator has a supply port for supplying oxidant therethrough, and an oxidant flow channel extending from the supply port.

The fuel flow channel and the oxidant flow channel each have an upstream portion continued from the supply port, a midstream portion continued from the upstream portion, and a downstream portion continued from the midstream portion.

The anode includes an anode catalyst layer disposed on one principal surface of the electrolyte membrane, and an anode diffusion layer being laminated on the anode catalyst layer and being in contact with the anode-side separator.

The cathode includes a cathode catalyst layer disposed on the other principal surface of the electrolyte membrane, and a cathode diffusion layer being laminated on the cathode catalyst layer and being in contact with the cathode-side separator.

The anode catalyst layer and the cathode catalyst layer each include a catalyst and a polymer electrolyte.

The anode catalyst layer faces the upstream portion, the midstream portion, and the downstream portion of the fuel flow channel.

The cathode catalyst layer faces the upstream portion, the midstream portion, and the downstream portion of the oxidant flow channel.

At least one of the anode catalyst layer and the cathode catalyst layer has a center portion and a peripheral portion surrounding the center portion.

The catalyst amount C_{2b} per unit projected area of a region facing the midstream portion within the peripheral portion and the catalyst amount C_{2c} per unit projected area of a region facing the downstream portion within the peripheral portion are each smaller than the catalyst amount C₁ per unit projected area of the center portion.

Another aspect of the present invention relates to a method for producing a catalyst-coated membrane for a direct oxidation fuel cell including an electrolyte membrane and catalyst layers formed on both principal surfaces of the electrolyte membrane. The method includes:

a step (A) of preparing a catalyst ink comprising a catalyst, a polymer electrolyte, and a dispersion medium; and

a step (B) of spraying the catalyst ink onto a predetermined region having a quadrilateral shape on at least one principal surface of the electrolyte membrane, thereby to form at least one of the catalyst layers.

The step (B) includes a process of spraying the catalyst ink in parallel to one side of the quadrilateral to form a belt-like coating extending in parallel to said one side, the process being repetitively performed from said one side to an opposing side opposite thereto of the quadrilateral, to form a plurality of belt-like coatings.

In the step (B), the belt-like coatings are formed such that: on one of said one side and the opposing side, an end of the belt-like coating coincides with the contour of the predetermined region, or alternatively, is inside the contour of the predetermined region; and on the other one of said one side and the opposing side, an end of the belt-like coating is outside the contour of the predetermined region.

### Advantageous Effects of Invention

According to the present invention, in a direct oxidation fuel cell, the catalyst utilization efficiency can be enhanced. Therefore, even when the amount of catalyst used is small, the power generation characteristics can be improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A longitudinal cross-sectional view schematically showing the structure of a unit cell included in a direct oxidation fuel cell according to one embodiment of the present invention

FIG. 2 A front view of an anode catalyst layer, as viewed in a direction normal to a principal surface thereof, included in the direct oxidation fuel cell according to one embodiment of the present invention

FIG. 3 A schematic cross-sectional view taken along the line III-III of FIG. 2

FIG. 4 A schematic cross-sectional view taken along the line IV-IV of FIG. 2

FIG. 5 A front view of a cathode catalyst layer, as viewed in a direction normal to a principal surface thereof, included in the direct oxidation fuel cell according to one embodiment of the present invention

FIG. 6 A schematic cross-sectional view taken along the line VI-VI of FIG. 5

FIG. 7 A schematic cross-sectional view taken along the line VII-VII of FIG. 2

FIG. 8 A schematic illustration of an exemplary structure of a spray coater used for forming a catalyst layer

FIG. 9 A schematic front view for explaining the conventional coating pattern of catalyst ink

FIG. 10 A schematic front view for explaining the conventional coating pattern of catalyst ink

FIG. 11 A schematic cross-sectional view of the coating pattern taken along the line XI-XI of FIG. 10

FIG. 12 A schematic front view for explaining a production method of a catalyst-coated membrane according to one embodiment of the present invention

FIG. 13 A schematic front view for explaining a production method of a catalyst-coated membrane according to one embodiment of the present invention

FIG. 14 A schematic cross-sectional view taken along the line XIV-XIV of FIG. 13 of the catalyst-coated membrane

### DESCRIPTION OF EMBODIMENTS

(Direct Oxidation Fuel Cell)

A direct oxidation fuel cell of the present invention has at least one unit cell. The unit cell includes: a membrane-electrode assembly including an anode, a cathode, and an electrolyte membrane interposed between the anode and the cathode; an anode-side separator being in contact with the anode; and a cathode-side separator being in contact with the cathode. The anode-side separator has a supply port for supplying fuel therethrough, and a fuel flow channel extending from the supply port. The cathode-side separator has a supply port for supplying oxidant therethrough, and an oxidant flow channel extending from the supply port. The fuel flow channel and the oxidant flow channel each have an upstream portion continued from the supply port, a midstream portion continued from the upstream portion, and a downstream portion continued from the midstream portion.

The anode includes an anode catalyst layer disposed on one principal surface of the electrolyte membrane, and an anode diffusion layer being laminated on the anode catalyst layer and being in contact with the anode-side separator. The cathode includes a cathode catalyst layer disposed on the other principal surface of the electrolyte membrane, and a cathode diffusion layer being laminated on the cathode catalyst layer and being in contact with the cathode-side separator. The anode catalyst layer and the cathode catalyst layer each include a catalyst and a polymer electrolyte.

The anode catalyst layer faces the upstream, midstream, and downstream portions of the fuel flow channel, and the cathode catalyst layer faces the upstream, midstream, and downstream portions of the oxidant flow channel. It should be noted that the upstream portion, the midstream portion, and the downstream portion of the fuel or oxidant flow channel are sometimes simply referred to as “the upstream”, “the midstream”, and “the downstream”, in this specification.

At least one of the anode catalyst layer and the cathode catalyst layer has a center portion and a peripheral portion surrounding the center portion. In the present invention, the catalyst amount C_{2b} per unit projected area of a region facing the midstream portion within the peripheral portion and the catalyst amount C_{2c} per unit projected area of a region facing the downstream portion within the peripheral portion are each smaller than the catalyst amount C₁ per unit projected area of the center portion.

In the fuel and oxidant flow channels of the separator, since the fuel and oxidant are consumed gradually to produce reaction products, the concentration of the fuel and oxidant contained in the fluid passing through the channel decreases in the midstream and downstream portions located away from the fuel or oxidant supply port. Even in the regions facing the midstream and downstream of the flow channel of the catalyst layer, in the center portion of the catalyst layer, in which a comparatively large amount of fuel or oxidant is diffused, a certain level of reaction efficiency can be maintained. However, in the regions facing the midstream and downstream of the flow channel within the peripheral portion surrounding the center portion of the catalyst layer, the reaction efficiency tends to be significantly lowered.

In the regions facing the midstream and downstream of the flow channel within the peripheral portion of the catalyst layer, increasing the amount of catalyst contained therein is considered to improve the reaction efficiency. However, when the catalyst amount is increased actually, the volume of pores in the regions facing the midstream and downstream portions in the catalyst layer is decreased in the process of heat-bonding the catalyst layer to the diffusion layer by hot-pressing or the like or of applying pressure for cell fabrication. If the pore volume of the catalyst layer is decreased, the diffusion of fuel or oxidant in the thickness direction of the catalyst layer is slowed, and as a result, the reaction efficiency is lowered. Moreover, in the above regions, since an increase in the catalyst amount results in lower reaction efficiency, a large amount of catalyst is left unreacted, and the catalyst utilization efficiency is lowered. Moreover, since the catalyst includes noble metal such as Pt, the production cost of the fuel cell is increased.

In the present invention, as described above, the catalyst amounts C_{2b} and C_{2c} per unit projected area of the regions facing the midstream and downstream portions within the peripheral portion are each smaller than the catalyst amount C₁ per unit projected area of the center portion. As such, the pore volume of the catalyst layer in these regions is unlikely to decrease in the process of heat-bonding the catalyst layer to the diffusion layer by hot-pressing or the like or of applying pressure for cell fabrication. This allows the fuel and oxidant to distribute efficiently, without slowing the diffusion of fuel and oxidant in the thickness direction of the catalyst layer.

In the regions facing the midstream and downstream portions within the peripheral portion of the catalyst layer, setting the catalyst amount therein smaller than that in the center portion is more effective than otherwise, for sufficiently improving the diffusibility of fuel and oxidant. Therefore, even though an organic fuel such as methanol is used by directly supplying it as a fuel to the anode, the oxidation speed is unlikely to decrease more than necessary, and thus, the overvoltage is unlikely to increase. These effects work synergetically to provide excellent power generation characteristics (power generation efficiency) and maintain a high power density over a long period of time. These effects can be obtained even when the catalyst amount is reduced. Therefore, the catalyst utilization efficiency can be enhanced. Furthermore, the amount used of the catalyst containing noble metal such as Pt can be reduced. This advantageously results in a decrease in production cost of the fuel cell.

A direct oxidation fuel cell and a method for producing a catalyst-coated membrane according to one embodiment of the present invention are described below with reference to the appended drawings.

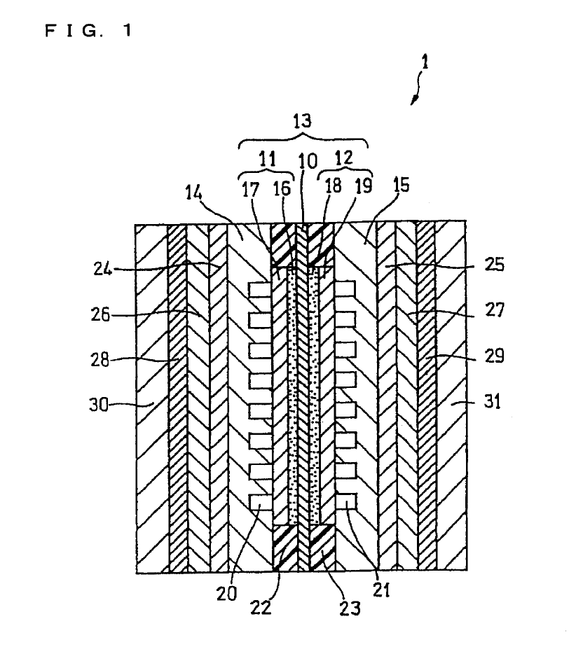

FIG. 1 is a longitudinal cross-sectional view schematically showing the structure of a unit cell included in a direct oxidation fuel cell according to one embodiment of the present invention.

A fuel cell 1 of FIG. 1 comprises one unit cell. The unit cell includes: an MEA 13 including a polymer electrolyte membrane 10, and an anode 11 and a cathode 12 sandwiching the polymer electrolyte membrane 10; and an anode-side separator 14 and a cathode-side separator 15 sandwiching the MEA 13.

The anode 11 includes an anode catalyst layer 16 disposed on one principal surface of the polymer electrolyte membrane 10, and an anode diffusion layer 17 laminated on the anode catalyst layer 16, and the anode diffusion layer 17 is in contact with the anode-side separator 14. The anode diffusion layer 17 includes a porous water-repellent layer in contact with the anode catalyst layer 16, and a porous substrate being laminated on the porous water-repellent layer and being in contact with the anode-side separator 14.

The cathode 12 includes a cathode catalyst layer 18 disposed on the other principal surface of the polymer electrolyte membrane 10, and a cathode diffusion layer 19 laminated on the cathode catalyst layer 18, and the cathode diffusion layer 19 is in contact with the cathode-side separator 15. The cathode diffusion layer 19 includes a porous water-repellent layer in contact with the cathode catalyst layer 18, and a porous substrate being laminated on the porous water-repellent layer and being in contact with the cathode-side separator 15.

The anode-side separator 14 has, on a surface facing the anode 11, a flow channel 20 for supplying fuel to the anode and discharging effluent containing unused fuel and reaction products (e.g., carbon dioxide). The cathode-side separator 15 has, on a surface facing the cathode 12, a flow channel 21 for supplying oxidant to the cathode and discharging effluent containing unused oxidant and reaction products. The oxidant is, for example, oxygen gas or a mixed gas containing oxygen gas such as air. Air is usually used as the oxidant.

Around the anode 11, an anode-side gasket 22 is disposed so as to seal the anode 11. Likewise, around the cathode 12, a cathode-side gasket 23 is disposed so as to seal the cathode 12. The anode-side gasket 22 and the cathode-side gasket 23 face each other with the polymer electrolyte membrane 10 therebetween. The anode-side and cathode-side gaskets 22 and 23 prevent the fuel, oxidant, reaction products from leaking outside.

The fuel cell 1 of FIG. 1 further includes current collector plates 24 and 25, sheet heaters 26 and 27, insulator plates 28 and 29, and end plates 30 and 31, which are stacked in the directions perpendicular to the plane directions of the anode-side and cathode-side separators 14 and 15. These components of the unit cell 1 are integrally held by clamping means (not shown).

In the present invention, in at least one of the anode catalyst layer 16 and the cathode catalyst layer 18, the amount of catalyst per unit projected area is set smaller in the regions facing the midstream and downstream of the flow channel on the separator within the peripheral portion than that in the center portion surrounded thereby.

The fuel flow channel and the oxidant flow channel each have a supply port for supplying fuel or oxidant therethrough, a fuel flow channel extending from the supply port, and a discharge port located at the end of the fuel flow channel, for discharging therethrough effluent from the flow channel. The upstream portion is a portion near the supply port in the flow channel, and the downstream portion is a portion near the discharge port in the flow channel. The midstream portion is a portion between the upstream and downstream portions.

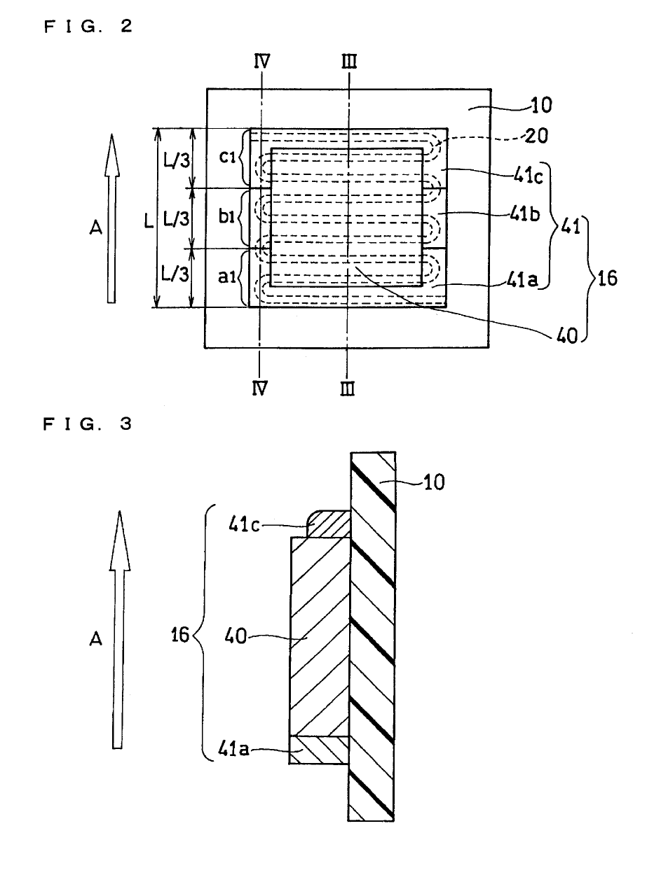

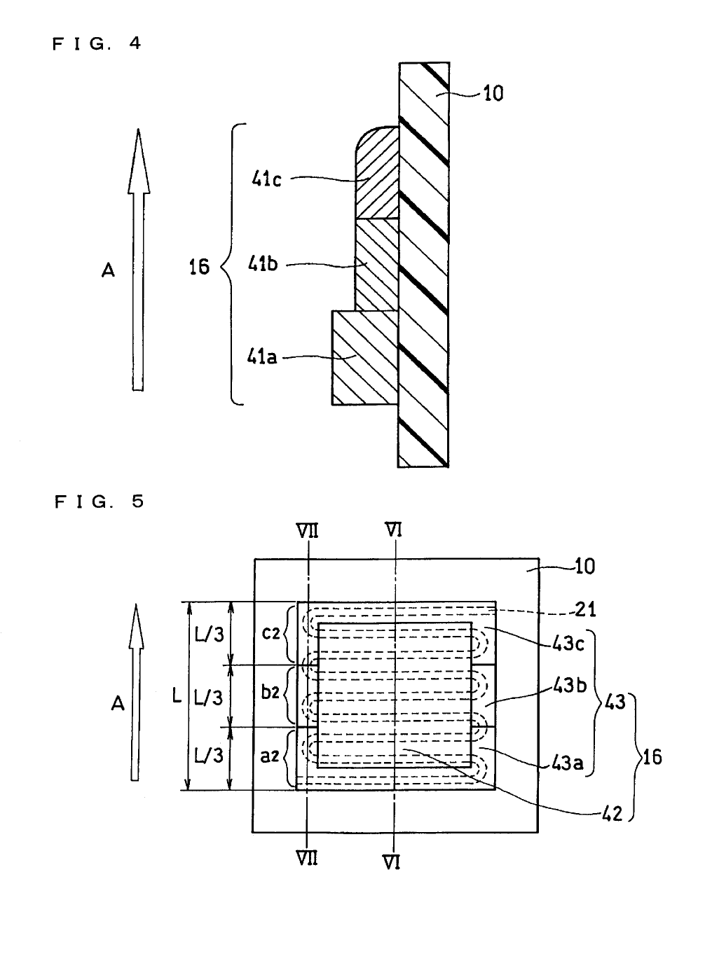

FIG. 2 is a front view of an anode catalyst layer, as viewed in a direction normal to a principal surface thereof, included in the direct oxidation fuel cell according to one embodiment of the present invention. FIGS. 3 and 4 are schematic cross-sectional views taken along the lines III-III and IV-IV of FIG. 2, respectively.

The anode catalyst layer 16 is formed in a quadrilateral shape on a predetermined region at the center of one principal surface of the electrolyte membrane 10, so as to face the fuel flow channel formed on the anode-side separator. In FIG. 2, the fuel flow channel 20 is shown in dotted lines for explaining how the anode catalyst layer 16 faces the fuel flow channel. The fuel flow channel 20 shown in FIG. 2 has a serpentine structure having a plurality of linear channels, and bends connecting the adjacent linear channels to each other.

The quadrilateral anode catalyst layer 16 has a quadrilateral center portion 40 and a frame-like peripheral portion 41 surrounding the center portion 40. The center portion 40 faces the main portion of the serpentine fuel flow channel 20 where the liner channels are evenly arranged, and the peripheral portion 41 face the bends of the fuel flow channel 20.

The fluid flowing inside the fuel flow channel 20 runs along the shape of the fuel flow channel 20 from the lower right toward the upper left in FIG. 2. The direction of the flow of the fluid as a whole running from upstream to downstream is indicated by arrow A in FIG. 2.

Given that the length of one side of the anode catalyst layer 16 parallel to arrow A is represented by “L”, and the flow channel is segmented into portions in the direction perpendicular to arrow A such that the “L” is equally divided into three, the portions on the upstream side and the downstream side can be defined as the upstream portion and downstream portion, respectively, and the portion between the upstream and downstream portions can be defined as the midstream portion. In short, the lengths of the regions of the anode catalyst layer 16 facing the upstream, midstream and downstream portions, as measured in the direction of arrow A, are each represented by “L/3”. As illustrated in FIG. 2, the anode catalyst layer 16 has a regional facing the upstream portion, a region b1 facing the midstream portion, and a region c1 facing the downstream portion of the fuel flow channel 20. These regions a1 to c1 each have a size of “L×L/3”.

In FIG. 2, the length L of one side of the anode catalyst layer parallel to the direction of the flow A of the fluid as a whole flowing through the fuel flow channel is equally divided into three, and the anode catalyst layer is divided into upstream, midstream and downstream regions each having a length on one side of L/3. However, without being limited to such an example, the length parallel to arrow A of these regions of the anode catalyst layer facing the upstream, midstream and downstream portions may be selected from the range of 0.3 L to 0.4 L, or from the range of 0.32 L to 0.36 L.

The peripheral portion 41 surrounding the center portion 40 of the anode catalyst layer 16 has a region 41a facing the upstream portion, a region 41b facing the midstream portion, and a region 41c facing the downstream portion. In the present embodiment, the catalyst amount C_{2b} per unit projected area of the region 41b facing the midstream portion and the catalyst amount C_{2c} per unit projected area of the region 41c facing the downstream portion are each smaller than the catalyst amount C₁ per unit projected area of the center portion 40.

Furthermore, in the cross section taken along the line III-III of FIG. 2, the center portion 40 and the region 41a facing the upstream portion has almost the same height (thickness) of the catalyst layer, but the thickness is reduced at the end portion of the region 41c facing the downstream portion. In the cross section taken along the line IV-IV, the thickness of the catalyst layer in the regions 41b and 41c facing the midstream and downstream portions is smaller than that in the region 41a facing the upstream portion, and the thickness is further reduced at the end portion of the region 41c.

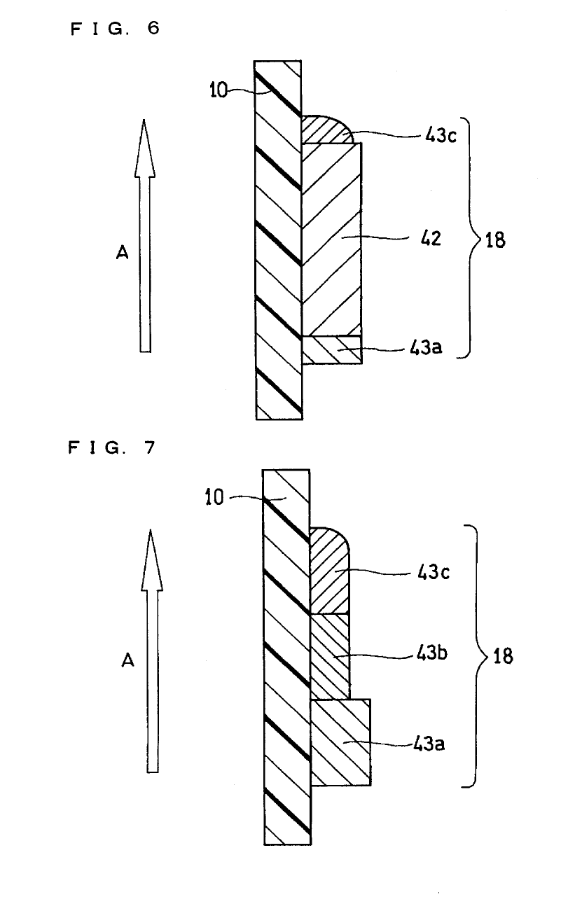

FIG. 5 is a front view of a cathode catalyst layer, as viewed in a direction normal to a principal surface thereof, included in the direct oxidation fuel cell according to one embodiment of the present invention. FIGS. 6 and 7 are schematic cross-sectional views taken along the lines VI-VI and VII-VII of FIG. 5, respectively.

The cathode catalyst layer 18 is formed in a quadrilateral shape on a predetermined region of the principal surface of the electrolyte membrane 10 opposite to the surface where the anode catalyst layer is formed, so as to face the oxidant flow channel formed on the cathode-side separator. In FIG. 5, the oxidant flow channel 21 is shown in dotted lines for explaining how the cathode catalyst layer 18 faces the oxidant flow channel. The oxidant flow channel 21 has a serpentine structure similar to that of the fuel flow channel 20 of FIG. 2.

The fluid flowing inside the oxidant flow channel 21 runs along the shape of the oxidant flow channel 21 from the lower left toward the upper right in FIG. 5. The direction of the flow of the fluid as a whole running from upstream to downstream through the oxidant flow channel 21 is indicated by arrow A in FIG. 5. Except that the direction of the oxidant flow channel 21 is reverse to that of the fuel flow channel 20, the configuration of the cathode catalyst layer 18 is the same as that in FIG. 2.

The cathode catalyst layer 18, like the anode catalyst layer 16 of FIG. 2, is quadrilateral in shape and has a quadrilateral center portion 42 and a frame-like peripheral portion 43 surrounding the center portion 42. In FIG. 5, given that the length of one side of the cathode catalyst layer 18 parallel to arrow A is represented by “L”, the cathode catalyst layer 18 has regions a2, b2 and c2 each having a size of “L×L/3”, which are defined by dividing the layer into three in the direction parallel to arrow A. The regions a2, b2 and c2 face the upstream, midstream, and downstream portions of the oxidant flow channel 21, respectively.

The peripheral portion 43 of the cathode catalyst layer 18 has regions 43a, 43b and 43c facing the upstream, midstream, and downstream portions of the oxide fuel channel, respectively. In the present embodiment, the catalyst amount C_{2b} per unit projected area of the region 43b and the catalyst amount C_{2c} per unit projected area of the region 43c facing the downstream portion within the peripheral portion are each smaller than the catalyst amount C₁ per unit projected area of the center portion 42.

In the present embodiment of FIGS. 2 and 5, the catalyst amounts C₁ and C₂ₐ to C_{2c} per unit projected area are a value obtained by dividing the amount (g) of catalyst present in the center portion or in each of the regions within the peripheral portion by the projected area (cm²) of the center portion or each of the regions within the peripheral portion.

The “projected area” is an area calculated using a contour as viewed in the direction normal to a principal surface of the catalyst layer. For example, when the contour of the catalyst layer as viewed in the normal direction thereof is rectangular, the projected area can be calculated from (length)×(width).

In the cross sections taken along the lines VI-VI and VII-VII of FIG. 5, the relationship among the heights (thicknesses) of the catalyst layer in the center portion and the regions within the peripheral portion is the same as those in FIGS. 3 and 4.

As described above, by setting the amount of catalyst smaller in the regions facing the midstream and downstream portions, the thickness of the catalyst layer can be reduced, and thus, the pore volume of the catalyst layer is unlikely to decrease in these regions in the process of heat-bonding the catalyst layer to the diffusion layer and of applying pressure for cell fabrication. As such, the diffusion of fuel in the direction along the thickness of the catalyst layer is unlikely to be slowed, and as a result, the power generation characteristics can be improved. Even though the amount of catalyst is partially reduced, excellent power generation characteristics can be obtained. Therefore, the catalyst utilization efficiency can be enhanced, and the overvoltage can be reduced.

It suffices if at least one of the anode and cathode catalyst layers has a distribution pattern of catalyst amount as described above. In the case where one of them has such a distribution pattern, the other may be a conventional catalyst layer. For example, in the case where the anode catalyst layer has a configuration as illustrated in FIGS. 2 to 4, the cathode catalyst layer may be a conventional cathode catalyst layer, or alternatively, a cathode catalyst layer having a configuration as illustrated in FIGS. 5 to 7. Conversely, in the case of using the cathode catalyst layer having a configuration as illustrated in FIGS. 5 to 7, the anode catalyst layer may be a conventional anode catalyst layer.

The ratios C_{2b}/C₁ (=R_{2b}) and C_{2c}/C₁ (=R_{2c}) of the catalyst amount C_{2b} and the catalyst amount C_{2c} in the regions facing the midstream and downstream portions within the peripheral portion, respectively, to the catalyst amount C₁ in the center portion are each, for example, 0.9 or less, and preferably 0.8 or less. The ratios R_{2b} and R_{2c} are each, for example, 0.1 or more, preferably 0.2 or more, and more preferably 0.4 or more. These upper and lower limits may be selected and combined with each other as appropriate. The ratios R_{2b} and R_{2c} each may be, for example, 0.1 to 0.9, or 0.2 to 0.8. When the ratios R_{2b} and R_{2c} are within such a range, the increase in overvoltage associated with shortage of catalyst can be more effectively suppressed, and the decrease in pore volume in the catalyst layer can be more effectively suppressed.

The ratio C₂ₐ/C₁ (═R₂ₐ) of the catalyst amount C₂ₐ in the region facing the upstream portion within the peripheral portion, to the catalyst amount C₁ in the center portion is, for example, 0.5 or more, preferably 0.9 or more, and more preferably 0.95 or more, or 1 or more. The ratio R₂ₐ may be, for example, 1.1 or less, and preferably 1.05 or less. These upper and lower limits may be selected and combined with each other as appropriate. The ratio R₂ₐ may be, for example, 0.5 to 1.1, or 0.95 to 1.05. By using a comparatively large amount of catalyst in the region within the peripheral portion facing the upstream of the flow channel where the fuel concentration or oxidant concentration is high, the reaction efficiency can be enhanced, and the decrease in cathode potential due to fuel crossover can be suppressed. Particularly, it is preferable to ensure that the amount of catalyst in the region facing the upstream portion within the peripheral portion is equal or nearly equal to that in the center portion.

The catalyst amounts C₂ₐ, C_{2b} and C_{2c} in the regions facing the upstream, midstream, and downstream portions, respectively, within the peripheral portion preferably satisfy the following relationship:

C₂ₐ>C_{2b}≧C_{2c}.

The relationship between C_{2b} and C_{2c} may be C_{2b}>C_{2c}. Preferably, the catalyst amount per unit projected area in each of the regions within the peripheral portion are decreased continuously or stepwise from upstream to downstream of the flow channel.

By configuring as above, the reaction efficiency can be more effectively enhanced on the upstream side where the fuel concentration and the oxidant concentration in the fluid flowing through the channel are high, while on the midstream and downstream sides where the fuel concentration and oxidant concentration in the fluid are low, the decrease in cathode potential due to fuel crossover can be more effectively suppressed. In addition, in the regions facing the midstream and downstream portions within the peripheral portion, the decrease in pore volume of the catalyst layer can be more effectively suppressed, and as a result, the catalyst utilization efficiency and the power generation characteristics can be achieved at a high level.

The shape of the predetermined region on which the catalyst layer is formed is quadrilateral such as square or rectangular (particularly, equiangular quadrilateral).

The peripheral portion has an outer periphery that coincides with the outer contour of the predetermined region and an inner periphery that coincides with the outer contour of the center portion, and is a frame-like portion surrounding the center portion formed between the outer periphery and the inner periphery.

The shape of the center portion is quadrilateral such as square or rectangular (particularly, equiangular quadrilateral).

Preferably, the center portion is geometrically similar to the outer periphery of the peripheral portion (i.e., to the predetermined region). The area of the center portion is, for example, 30 to 90%, preferably 40 to 85%, and more preferably 50 to 80%, or 55 to 80% of the projected area of the predetermined region.

Given that the projected area of the center portion is represented by “A₁”, the projected areas of the regions facing the upstream, midstream, and downstream portions within the peripheral portion are represented by “A₂ₐ”, “A_{2b}” and “A_{2c}”, the ratio (A_{2b}+A_{2c})/(A₁+A₂ₐ+A_{2b}+A_{2c}) of the total of the projected areas of the regions facing the midstream and downstream portions within the peripheral portion (the total of A_{2b} and A_{2c}) to the projected area of the catalyst layer as a whole (the total of A₁, A₂ₐ, A_{2b} and A_{2c}) is, for example, 0.05 or more, preferably 0.08 or more, and more preferably 0.1 or more. The ratio (A_{2b}+A_{2c})/(A₁+A₂ₐ+A_{2b}+A_{2c}) is, for example, 0.6 or less, preferably 0.55 or less, and more preferably 0.51 or less, or 0.5 or less. These upper and lower limits may be selected and combined with each other as appropriate. The ratio (A_{2b}+A_{2c})/(A₁+A₂ₐ+A_{2b}+A_{2c}) may be, for example, 0.05 to 0.6, or 0.1 to 0.51.

When the ratio (A_{2b}+A_{2c})/(A₁+A₂ₐ+A_{2b}+A_{2c}) is within the above range, it is possible to more effectively suppress the decrease in the pore volume of the catalyst layer in these regions, in the process of heat-bonding the catalyst layer to the diffusion layer or of applying pressure for cell fabrication, and thus to more effectively prevent the diffusion of fuel or oxidant from being slowed. In addition, it is possible to easily ensure a sufficient amount of catalyst in the catalyst layer, and therefore, the increase in overvoltage can be suppressed.

The anode catalyst layer and the cathode catalyst layer each include, for example, electrically conductive carbon particles, a catalyst supported thereon, and a polymer electrolyte.

When the anode catalyst layer has a distribution pattern of catalyst amount as described above, the catalyst amount C₁ in the center portion is, for example, 0.8 mg/cm² or more, preferably 1 mg/cm² or more, and more preferably 2 mg/cm² or more, or 2.5 mg/cm² or more. The catalyst amount C₁ is, for example, 4 mg/cm² or less, and preferably 3.5 mg/cm² or less. These upper and lower limits may be selected and combined with each other as appropriate. The catalyst amount C₁ may be, for example, 0.8 to 4 mg/cm², or 1 to 4 mg/cm².

When the cathode catalyst layer has a distribution pattern of catalyst amount as described above, the catalyst amount C₁ in the center portion is, for example, 0.6 mg/cm² or more, preferably 0.8 mg/cm² or more, and more preferably 1 mg/cm² or more. The catalyst amount C₁ is, for example, 3 mg/cm² or less, preferably 2.5 mg/cm² or less, and more preferably 2 mg/cm² or less. These upper and lower limits may be selected and combined with each other as appropriate. The catalyst amount C₁ may be, for example, 0.6 to 3 mg/cm², or 0.8 to 2 mg/cm².

Since the conductive carbon particles tend to aggregate to form secondary particles in the anode catalyst layer and cathode catalyst layer, these catalyst layers are likely to become more porous. As such, even when the catalyst amount C₁ in the center portion is within the range as above, the three-phase interfaces serving as the electrode reaction sites can be more effectively ensured. Therefore, the increase in anode overvoltage or cathode overvoltage can be suppressed.

The catalyst-coated membrane (CCM) in which catalyst layers are formed on principal surfaces of an electrolyte membrane can be formed through a step of (A) of preparing a catalyst ink including a catalyst, a polymer electrolyte, and a dispersion medium, and a step (B) of spraying the catalyst ink onto a predetermined region having a quadrilateral shape on at least one principal surface of the electrolyte membrane, thereby to form at least one of the catalyst layers.

In order to form a catalyst layer having a distribution pattern of catalyst amount as described above on a principal surface of the electrolyte membrane, the catalyst ink is sprayed in a specific manner in the step (B). In the CCM, which includes an electrolyte membrane and catalyst layers formed on both principal surfaces of the electrolyte membrane, it suffices if at least one of both catalyst layers has a distribution pattern of catalyst amount as described above.

The step (B) includes a process of spraying the catalyst ink in parallel to one side of the quadrilateral to form a belt-like coating extending in parallel to said one side. By repetitively performing the spraying from said one side to an opposing side opposite thereto of the quadrilateral, one of the catalyst layers can be formed. At this time, the belt-like coatings are formed such that: on one of said one side and the opposing side, an end of the belt-like coating (outermost end of the belt-like coatings) coincides with the contour of the predetermined region, or alternatively, is inside the contour of the predetermined region; and on the other one of said one side and the opposing side, an end of the belt-like coating (outermost end of the belt-like coatings) is outside (or extends from) the contour of the predetermined region.

When the belt-like coatings are formed such that an end of the belt-like coating (outermost end of the belt-like coatings) coincides with the contour of the predetermined region, or alternatively, is inside the contour, the absolute amount of catalyst is reduced in this area (particularly near the contour of the predetermined region), and therefore, the amount of catalyst per unit projected area is reduced. In the center area of the predetermined region on which the catalyst layer is formed, the belt-like coatings are evenly formed. As such, the amount of catalyst per unit projected area in the area where an end of the belt-like coating (outermost end of the belt-like coatings) coincides with the contour of the predetermined region, or alternatively, is inside the contour is smaller than that in the center area. By arranging such an area in which the amount of catalyst per unit projected area is reduced, to face the midstream and downstream of the flow channel on the separator, the power generation characteristics can be improved, and at the same time, the catalyst utilization efficiency can be enhanced.

Furthermore, on the other one of said one side and the opposing side, in an area where the belt-like coatings are formed such that an end of the belt-like coating (outermost end of the belt-like coatings) is outside the contour of the predetermined region, a certain large amount of catalyst can be ensured. By arranging such an area to face the upstream side of the separator, the power generation characteristics tend to be improved.

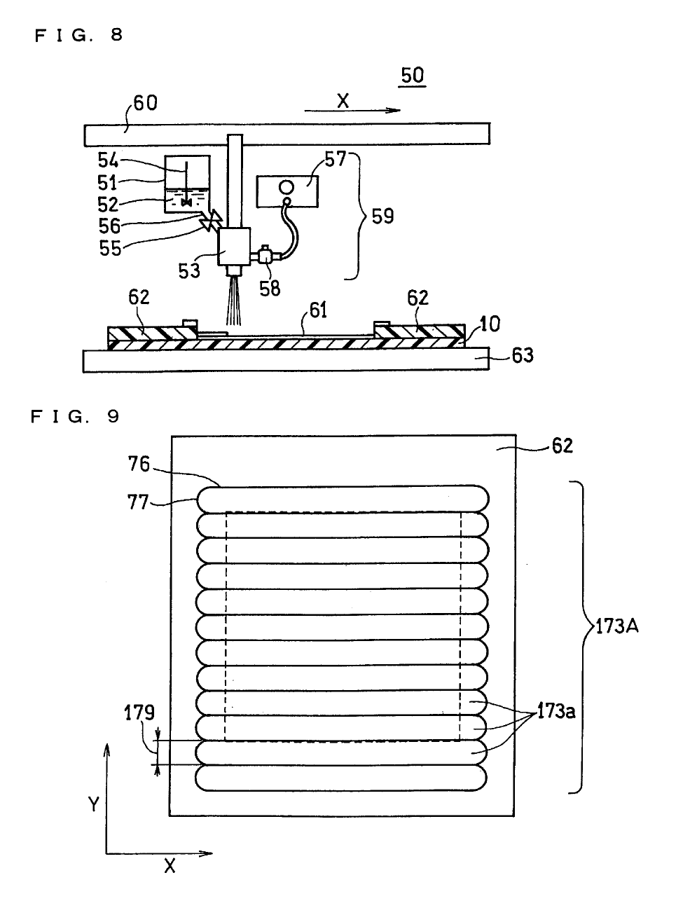

FIG. 8 is a schematic illustration of an exemplary structure of a spray coater used for forming a catalyst layer. A spray coater 50 has a tank 51 containing a catalyst ink 52, and a spray gun 53. In the tank 51, the catalyst ink 52 is being stirred with a stirrer 54 and is always in a flowing state. The catalyst ink 52 is fed to the spray gun 53 through a supply pipe 56 equipped with an open/close valve 55, and is ejected together with a jet gas from the spray gun 53. The jet gas is supplied to the spray gun 53 via a gas pressure regulator 57 and a gas flow regulator 58. The jet gas that can be used here is, for example, nitrogen gas.

In the spray coater 50, a spray gun unit 59 is movable by an actuator 60 from any position at any speed in two directions: the X axis parallel to arrow X, and the Y axis perpendicular to the X axis and to the drawing sheet.

The electrolyte membrane 10 is placed below the spray gun 53. The spray gun 53 is moved linearly while the catalyst ink 52 is being ejected, thereby to deposit the catalyst ink 52 on the electrolyte membrane 10. At this time, the size and shape of an area to be coated (predetermined region) 61 of the catalyst ink 52 on the electrolyte membrane 10 can be adjusted using a mask 62. The surface temperature of the electrolyte membrane 10 is adjusted using a heater 63.

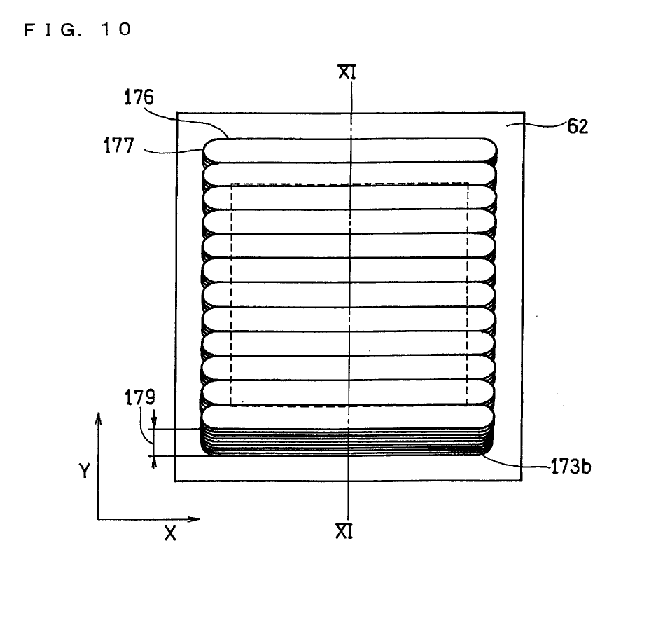

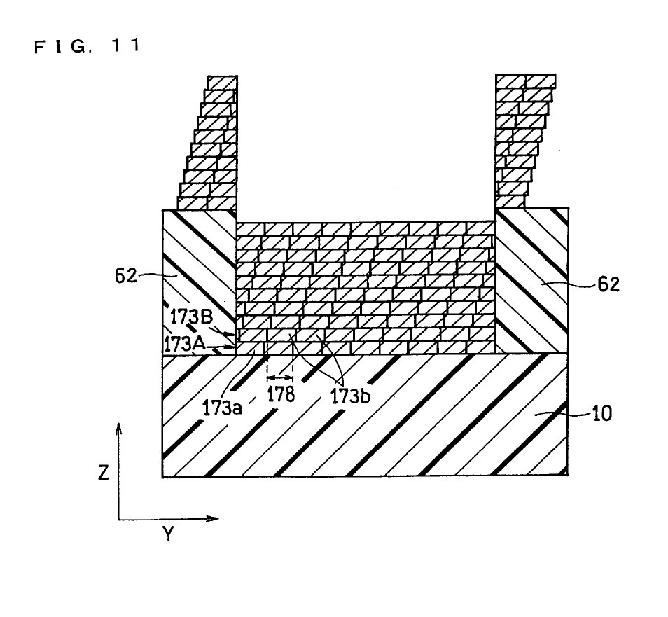

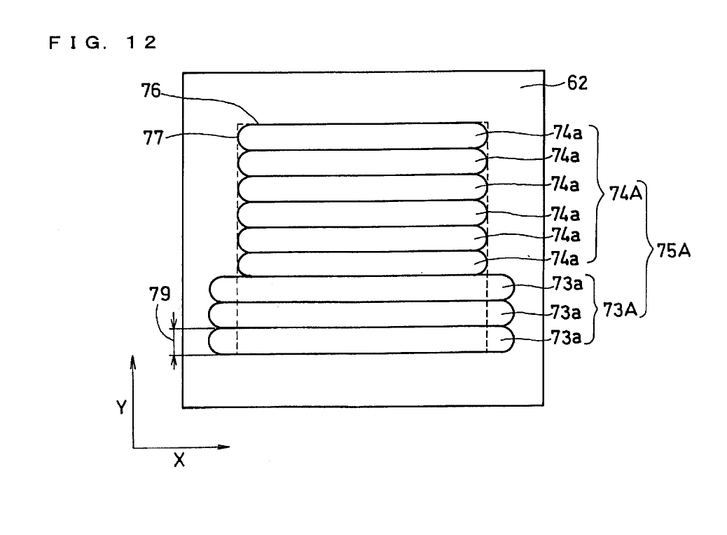

FIGS. 9 and 10 are schematic front views for explaining the method of applying catalyst ink in the conventional pattern using the apparatus of FIG. 8. FIG. 11 is a schematic cross-sectional view taken along the line XI-XI of FIG. 10. FIG. 10 illustrates a state in which the catalyst ink is applied in multiple layers, and FIG. 9 illustrates the first layer thereof.

A mask 62 provided at its center with a quadrilateral cut-out portion corresponding to the predetermined region is placed on one principal surface of the electrolyte membrane 10. In this state, a catalyst ink is sprayed from the spray gun 53 toward the cut-out portion. At this time, while the spray gun 53 is being moved in parallel to one side of the predetermined region (in the X-axis direction), the catalyst ink is sprayed onto the electrolyte membrane 10, to form a belt-like coating 173a. The formation of the belt-like coating 173a is repeated from said one side toward the opposing side (in the Y-axis direction), to form a plurality of the belt-like coatings 173a arranged side by side in the Y-axis direction. In this manner, a group of coatings 173A of the first layer is formed.

Subsequently, in the same manner as forming the first layer, a plurality of belt-like coatings 173b whose longitudinal direction is in the X-axis direction are arranged side by side in the Y-axis direction so as to be stacked on the group of coatings 173A of the first layer in the thickness direction (in the Z-axis direction perpendicular to the drawing sheet), thereby to form a group of coatings 173B of the second layer. The stacking is repeated, and thus, a catalyst layer is formed. By forming the belt-like coatings side by side in the Y-axis direction, the catalyst can be evenly distributed. By stacking the groups of coatings in the thickness direction, the catalyst can be evenly distributed also in the thickness direction.

The belt-like coatings 173a and 173b are formed such that an end 176 in the longitudinal direction thereof and an end 177 in the lateral direction thereof are outside (or extend from) four sides of the quadrilateral predetermined region. As such, the catalyst can be evenly distributed to every corner of the predetermined region. However, the portions of the coatings 173a and 173b formed outside the predetermined region are on the mask 62, resulting in a large material loss. The mask 62 is finally removed, and a catalyst layer formed on the predetermined region can be obtained.

Here, in FIGS. 9 to 11, for clarification of the forming method of belt-like coatings, the overlap between the belt-like coatings adjacent to each other within the same layer (in the direction parallel to the principal surface of the electrolyte membrane, i.e., the Y-axis direction) is set to 0% of a width 179 of the belt-like coating. However, in order to distribute the catalyst more evenly, the belt-like coatings may be formed such that adjacent coatings partially overlap with each other by, for example, 40% or less, and preferably 5 to 30%, or 10 to 25% of the width of the belt-like coating.

The belt-like coatings may be stacked such that the belt-like coatings adjacent to each other in the thickness direction overlap with each other by 100%, that is, the belt-like coatings in the lower layer and those in the upper layer completely overlap with each other. Alternatively, as illustrated in FIG. 11, they may be stacked such that one belt-like coating in the upper layer overlaps with two belt-like coatings in the lower layer. A width 178 of a larger size portion of the overlap between adjacent belt-like coatings in the direction perpendicular to the principal surface of the electrolyte membrane (in the stacking direction or Z-axis direction) can be set to, for example, 50 to 90% of the width of each belt-like coating.

In the catalyst layer formed as illustrated in FIGS. 9 to 11, the catalyst is substantially evenly distributed all over the predetermined region. Even provided that the predetermined region has a center portion and a peripheral portion surrounding the center portion, there is almost no difference between the amounts of catalyst per unit projected area in the center portion and in the peripheral portion.

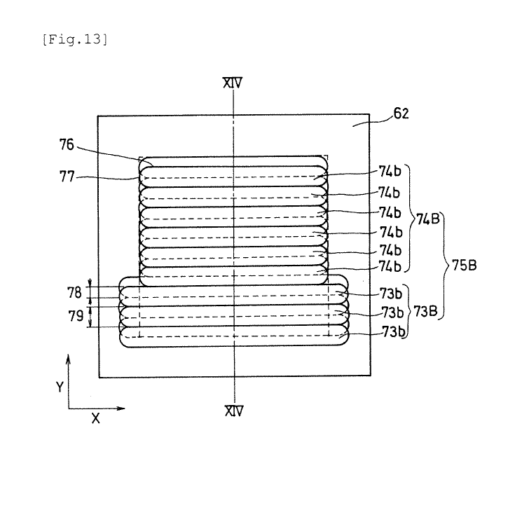

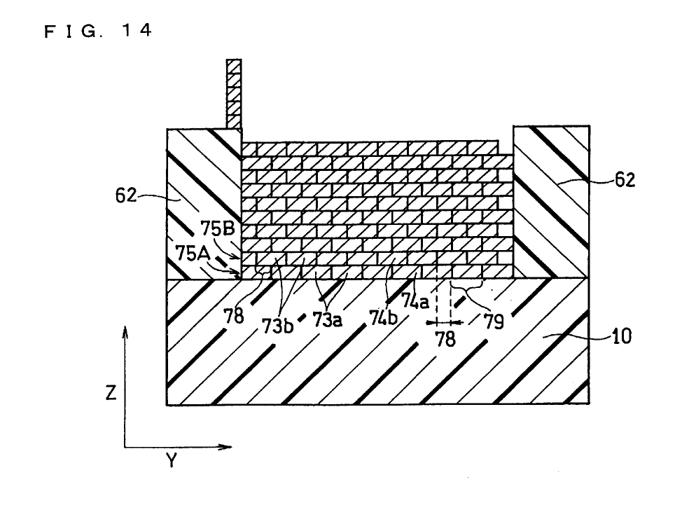

FIGS. 12 and 13 are schematic front views for explaining a production method of a CCM according to one embodiment of the present invention, and FIG. 14 is a schematic cross-sectional view of the CCM, taken along the line XIV-XIV of FIG. 13. The CCM is formed using, for example, a spray coater as illustrated in FIG. 8.

FIG. 13 illustrates a state in which the catalyst layer is applied in two layers, and FIG. 12 shows the first layer thereof.

In FIGS. 12 to 14 also, like in FIGS. 9 to 11, a catalyst ink is sprayed onto the electrolyte membrane 10 while the spray gun 53 is being moved in parallel to one side of the predetermined region (in the X-axis direction), to form a belt-like coatings 73a and 74a each having a width 79. The formation of the belt-like coatings 73a and 74a are repeated from said one side toward the opposing side (in the Y-axis direction), to form a plurality of the belt-like coatings 73a and 74a arranged side by side in the Y-axis direction. In this manner, groups of coatings 73A and 74A are formed, which collectively constitute a group of coatings 75A of the first layer. Subsequently, in the same manner as forming the first layer, a plurality of belt-like coatings 73b and 74b whose longitudinal direction is in the X-axis direction are arranged side by side in the Y-axis direction so as to be stacked on the group of coatings 75A of the first layer in the thickness direction (in the Z-axis direction perpendicular to the drawing sheet), thereby to form a group of coatings 75B of the second layer. The stacking is repeated, and thus, a catalyst layer is formed.

The belt-like coatings 73b and 74b of the second layer are stacked in the Z-axis direction such that they overlap with the belt-like coatings 73a and 74a of the first layer adjacent thereto by a width 78. The overlap between adjacent belt-like coatings in the stacking direction or thickness direction (in the Z-axis direction) corresponds to the width of a larger size portion of the overlap between adjacent belt-like coatings in the Z-axis direction.

In FIGS. 12 to 14, the belt-like coatings 73a are formed such that: on one of said one side and the opposing side, an end of the belt-like coating 73a (an outermost end 76 in the longitudinal direction and/or ends 77 in the lateral direction of the belt-like coatings) coincides with the contour of the predetermined region, or alternatively, is inside the contour of the predetermined region.

By forming like this, an area where the amount of catalyst per unit projected area is small is formed near the contour of the predetermined region. And by arranging such an area to face the midstream and downstream of the flow channel of the separator, excellent power generation characteristics and enhanced catalyst utilization efficiency can be obtained. Moreover, by positioning an end of the belt-like coating (outermost end of the belt-like coatings) to coincide with or be inside the contour of the predetermined region, the catalyst is unlikely to be left on the mask in this area. Accordingly, the material loss in the application process of catalyst ink can be reduced effectively.

The application pattern as described above can be obtained by, for example, setting the moving distance of the spray gun 53 when moved linearly in the X-axis direction for forming the belt-like coating 73a, to be smaller than the length of one side of the predetermined region. Alternatively, it can be obtained by increasing the width of the overlap between the belt-like coatings 73a adjacent to each other.

In FIGS. 12 to 14, on the other one of said one side and the opposing side, the belt-like coatings are formed such that an end of the belt-like coating is outside the contour of the predetermined region. In other words, in this area, the belt-like coatings are formed like in FIGS. 9 and 11. As such, in this area, the catalyst can be evenly distributed to every corner of the predetermined region, and a comparatively large amount of catalyst can be held. By arranging such an area to face the upstream side of the separator, excellent power generation characteristics can be readily obtained.

The end of the belt-like coating can be positioned outside the contour of the predetermined region by, for example, setting the moving distance of the spray gun 53 in the X-axis direction, to be larger than the length of one side of the predetermined region, or alternatively, decreasing the width of the overlap between the belt-like coatings 73a adjacent to each other.

In the present invention, either one of the anode and cathode catalyst layers is formed by forming belt-like coatings such that: on one of one side and an opposing side opposite thereto of a quadrilateral predetermined region on the electrolyte membrane, an end of the belt-like coating (outermost end in the longitudinal direction and/or ends in the lateral direction of the belt-like coatings) coincides with or is inside the contour of the predetermined region. Both of the anode and cathode catalyst layers may be formed in such a manner, or alternatively, either one of them may be formed in such a manner, while the other one of them is formed by the conventional method as explained in FIGS. 9 to 11.

In FIGS. 12 to 14, for clarification of the forming method of belt-like coatings, the overlap between the belt-like coatings adjacent to each other within the same layer (in the direction parallel to the principal surface of the electrolyte membrane, i.e., in the Y-axis direction) is set to 0% of the width 79 of the belt-like coating. However, in order to distribute the catalyst more evenly, the belt-like coatings may be formed such that adjacent coatings partially overlap with each other.

The overlap between the belt-like coatings adjacent to each other in the Y-axis direction is 0% or more, preferably 5% or more, and more preferably 10% or more of the width 79 of the belt-like coating. The overlap between the belt-like coatings adjacent to each other in the Y-axis direction is, for example, 40% or less, preferably 30% or less, and more preferably 25% or less of the width 79 of the belt-like coating. These upper and lower limits may be selected and combined with each other as appropriate. The overlap between the belt-like coatings adjacent to each other in the Y-axis direction may be, for example, 0 to 40%, or 0 to 25%.

When the overlap between adjacent belt-like coatings in the Y-axis direction is set within such a range, it is unlikely that the catalyst ink is applied and stacked one after another while a larger part thereof is still wet. Therefore, cracks (crevices) are less likely to occur in the catalyst layer, and the resultant catalyst layer can have excellent proton conductivity and excellent diffusibility of fuel and oxidant.

As illustrated in FIGS. 13 and 14, one belt-like coating in the upper layer may overlap with two belt-like coatings in the lower layer. Without being limited thereto, the belt-like coatings adjacent to each other in the direction perpendicular to the principal surface of the electrolyte (in the stacking direction or Z-axis direction) may overlap with each other by 100%, that is, the belt-like coatings in the lower layer and those in the upper layer may completely overlap with each other.

The width of a larger size portion of the overlap (i.e., the width of the overlap) between adjacent belt-like coatings in the Z-axis direction may be set to, for example, 40% of more, and preferably 45% or more of the width of the belt-like coating. The width of the overlap between adjacent belt-like coatings in the Z-axis direction may be set to, for example, 85% or less, preferably 80% or less, and more preferably 70% or less, or 60% or less of the width of the belt-like coating. These upper and lower limits may be selected and combined with each other as appropriate. The width of the overlap between adjacent belt-like coatings in the Z-axis direction may be, for example, 40 to 85%, or 40 to 60%.

When the width of the overlap between adjacent belt-like coatings in the Z-axis direction is within such a range, the catalyst can be more evenly distributed in the thickness direction of the catalyst layer, while the material loss resulted from the adhesion of catalyst ink on the mask in the application process can be more effectively reduced.

In the regions facing the midstream and downstream portions within the peripheral portion, the length of the belt-like coating may be set to 30 to 95% or preferably 35 to 90% of the length of the side of the predetermined region parallel to the longitudinal direction of the belt-like coating (i.e., the length of the side in the X-axis direction). The length of the belt-like coating can be adjusted by changing the moving distance of the spray gun, the amount of catalyst ink sprayed, and the like. Alternatively, the moving distance of the spray gun in the X-direction may be set as appropriate within the above range.

In stacking groups of belt-like coatings to form a catalyst layer, the length, width, and/or number of the belt-like coating may be changed in each layer. For example, the length of the belt-like coating (or the moving distance of the spray gun in the X-axis direction) may be set to 60 to 95% (preferably 70 to 95%) in the odd-number-th layers (or even-number-th layers) and 40 to 70% (preferably 40 to 65%) in the even-number-th layers (or odd-number-th layers), relative to the length of the side of the predetermined region parallel to the longitudinal direction of the belt-like coating.

The width of the belt-like coating can be controlled by adjusting the viscosity of catalyst ink, the amount of catalyst ink sprayed, the clearance between the tip end of the spray gun and the electrolyte membrane, and the like. The viscosity of catalyst ink can be adjusted by changing the dispersing conditions when preparing a catalyst ink (e.g., the amount of catalyst or conductive carbon particles, and the type or amount of dispersion medium). The amount of catalyst ink sprayed can be adjusted by changing the pressure and flow rate of jet gas. The clearance between the tip end of the spray gun and the electrolyte membrane is preferably 5 cm or more and 10 cm or less. By adjusting the clearance between the tip end of the spray gun and the electrolyte membrane, the catalyst ink is unlikely to be bounced back (rebound) from the electrolyte membrane when deposited thereon, and the material loss due to scattering of catalyst ink into the air can be reduced.

The width of the belt-like coating can be increased by lowering the viscosity of catalyst ink, increasing the amount of catalyst ink sprayed, or increasing the clearance between the tip end of the spray gun and the electrolyte membrane.

The surface temperature of the electrolyte membrane when the catalyst ink is sprayed thereonto is, for example, 50 to 80° C., and preferably 60 to 80° C. When the surface temperature of the electrolyte membrane when the catalyst ink is sprayed thereonto is within such a range, it is unlikely that the catalyst ink is applied and stacked one after another while it is still wet. Therefore, cracks (crevices) are less likely to occur in the catalyst layer, and the resultant catalyst layer can have excellent proton conductivity and excellent diffusibility of fuel and oxidant.

A detailed description is given below of the configurations of the DOFC and CCM.

(Catalyst Layer)

The catalyst layer includes a catalyst and a polymer electrolyte.

The anode catalyst used in the anode catalyst layer is preferably particles containing a noble metal such as Pt. A preferable example thereof is Pt—Ru alloy particles.

The cathode catalyst used in the cathode catalyst layer is preferably particles containing a noble metal such as Pt. Examples thereof include Pt particles and Pt—Co alloy particles.

The average particle diameter of the catalyst is, for example, 1 to 10 nm, and preferably 1 to 3 nm.

The “average particle diameter” as used herein refers to a median diameter in a volumetric particle size distribution.

The catalyst may be used as it is, or may be supported on a support (catalyst support). The support may be any material known as a catalyst support, and may be, for example, carbon particles such as electrically conductive carbon particles (e.g., carbon black). The average particle diameter of primary particles of the carbon particles is, for example, 5 to 50 nm, and preferably, 10 to 50 nm.

The polymer electrolyte may be any known material excellent in proton conductivity, heat resistance, and chemical stability, such as an ion-exchange resin. Specifically, preferable examples of the ion-exchange resin include: an ion-exchange resin having a sulfonic acid group as an ion-exchange group, such as a resin having a perfluorosulfonylalkyl group at its side chain (perfluorosulfonic acid-based resin); and a sulfonated polymer. The perfluorosulfonic acid-based resin is exemplified by a homopolymer or copolymer including a fluoroalkylene unit having a perfluorosulfonylalkyl group at its side chain, such as Nafion (registered trademark) and Flemion (registered trademark).

Each catalyst layer can be formed by spraying a catalyst ink onto one principal surface of the electrolyte membrane using, for example, a spray coater equipped with a spray gun as describe above, and then drying the ink.

The catalyst ink includes a catalyst, a polymer electrolyte, and a dispersion medium. Examples of the dispersion medium include water, alcohol (e.g., linear or branched C₁₋₄alkanol, such as methanol, ethanol, propanol, and isopropanol), and mixtures of these.

The porosity of each catalyst layer is, for example, 60 to 90%, and preferably 70 to 90%.

When the porosity of the catalyst layer is within such a range, the presence of distribution paths in the catalyst layer which are effective for diffusing fuel or oxidant and discharging reaction products (carbon dioxide at the anode, and water etc. at the cathode) can be more effectively ensured, and the electron conductivity and proton conductivity can be more effectively improved. As a result, the overvoltage in each catalyst layer can be decreased.

The porosity of the catalyst layer can be determined by, for example, photographing a cross section of the catalyst layer at given 10 points using a scanning electron microscope, and image-processing (thresholding) the obtained image data.

In the present invention, it suffices if the distribution of catalyst is controlled as above in either one of the anode and cathode catalyst layers, and the configuration other than the catalyst layer may be the same as conventionally known in the art.

(Electrolyte Membrane)

The electrolyte membrane may be formed of any known material excellent in proton conductivity, heat resistance, and chemical stability. The electrolyte membrane includes, for example, a porous core material such as resin non-woven fabric, and a polymer electrolyte impregnated into the porous core material. The polymer electrolyte may be any type of polymer electrolyte that does not impair the characteristics of the electrolyte membrane, and may be those as exemplified in the section of the catalyst layer.

(Diffusion Layer)

The anode diffusion layer and cathode diffusion layer each includes a porous water-repellent layer (or a porous composite layer) in contact with the catalyst layer, and a porous substrate being laminated on the porous water-repellent layer and being in contact with the separator.

The porous water-repellent layer includes electrically conductive carbon particles and a water-repellent resin material (or a water-repellent binder material). Examples of the conductive carbon particles include carbon black and graphite. Preferably, the conductive carbon particles are mainly composed of electrically conductive carbon black. The conductive carbon black preferably has a specific surface area of about 200 to 300 m²/g.

The water-repellent resin material is exemplified by a homopolymer or copolymer having a fluorine-containing monomer unit, such as polytetrafluoroethylene, tetrafluoroethylene-hexafluoropropylene copolymer, tetrafluoroethylene-perfluoroalkyl vinyl ether copolymer, tetrafluoroethylene-ethylene copolymer, polyvinylidene fluoride (PVDF), and polyvinyl fluoride.

The amount of the porous water-repellent layer (the total amount of the conductive carbon particles and water-repellent resin material per unit projected area of the porous water-repellent layer) is, for example, 1 to 3 mg/cm². The projected area of the porous water-repellent layer can be calculated similarly to that of the catalyst layer.

The porous substrate used for the diffusion layer is preferably an electrically conductive porous substrate, in view of the diffusibility of fuel or oxidant, the ability to discharge reaction products (carbon dioxide at the anode, and water (including water moved from the anode) etc. at the cathode), electron conductivity, and other factors. Such a conductive porous substrate is exemplified by a carbon material being porous and sheet-like. Specifically, examples thereof include carbon paper, carbon cloth, and carbon non-woven fabric.

(Separator)

The anode-side separator and cathode-side separator may be any separator that has hermeticity, electron conductivity, and electrochemical stability. The material of the separator is not particularly limited, and may be, for example, a carbon material, or a carbon-coated metal material.

The shape of the flow channels (fuel flow channel and oxidant flow channel) formed on the separator is also not particularly limited, and may be, for example, a serpentine shape or parallel shape.

(Others)

The current collector plate, sheet heater, insulator plate, and end plate may be those known in the art.

The fuel is not particularly limited, and may be, for example, an organic liquid fuel such methanol or dimethyl ether.

The MEA can be formed by any known method. For example, (i) a cathode catalyst layer is formed on one principal surface of an electrolyte membrane, and an anode catalyst layer is formed on the other principal surface thereof, to form a CCM, (ii) a cathode porous water-repellent layer is formed on one surface of a cathode porous substrate, and an anode porous water-repellent layer is formed on a surface of an anode porous substrate, to form a cathode diffusion layer and an anode diffusion layer, and (iii) the cathode diffusion layer is stacked on one surface of the CCM and the anode diffusion layer is stacked on the other surface thereof such that the catalyst layer and the porous water-repellent layer contact with each other, and the resultant stack is secured by bonding, thereby to form an MEA in which the electrolyte membrane is sandwiched between the cathode and the anode.

Each of the layers can be formed by applying a paste including constituent components onto a layer serving as a base, and drying the paste. In forming each of the layers, if necessary, heat may be applied as appropriate. The bonding of the stack may be done by, for example, hot-pressing.

The DOFC can be produced by any known method. For example, an anode-side gasket and a cathode-side gasket are disposed around the anode and cathode of the MEA, so as to sandwich the electrolyte membrane, and then the MEA with the gaskets is sandwiched from both sides between anode-side and cathode-side separators, current collector plates, sheet heaters, insulator plates, and end plates, and secured with clamping rods, thereby to produce a DOFC.

### EXAMPLES

The present invention is specifically described below by way of Examples and Comparative Examples, but these Examples are not to be construed as limiting the present invention.

### Example 1

A direct oxidation fuel cell as illustrated in FIG. 1 was produced by the following procedures.

### (1) Production of Catalyst-Coated Membrane (CCM)

A catalyst-coated membrane (CCM) was produced by forming an anode catalyst layer 16 on one surface of an electrolyte membrane 10 and a cathode catalyst layer 18 on the other surface thereof as described below.

### (1-1) Production of Anode Catalyst Layer

### (a) Preparation of Anode Catalyst Ink

Conductive carbon particles supporting Pt—Ru fine particles (Pt:Ru (weight ratio)=3:2, average particle diameter: 2 nm) were used as an anode catalyst. The conductive carbon particles used here were carbon black (Ketjen black EC available from Mitsubishi Chemical Corporation, average particle diameter of primary particles: 30 nm). The mass ratio of the Pt—Ru fine particles to the total mass of the Pt—Ru fine particles and the conductive carbon particles was set to 73 mass %.

The anode catalyst was ultrasonically dispersed in an aqueous isopropanol solution (concentration of isopropanol: 50 mass %) for 60 minutes. To the resultant dispersion, a predetermined amount of an aqueous solution of polymer electrolyte was added, and stirred with a disper, to prepare an anode catalyst ink. The amount of the aqueous solution of polymer electrolyte added was adjusted so that the mass ratio of the polymer electrolyte to the total solids in the anode catalyst ink became 28 mass %. The aqueous solution of polymer electrolyte used here was a solution containing 5 mass % of perfluorosulfonic acid polymer whose ion exchange capacity IEC was in the range of 0.95 to 1.03 (an aqueous solution of 5 mass % Nafion (registered trademark) available from Sigma-Aldrich Co. LLC.).

### (b) Formation of Anode Catalyst Layer

The anode catalyst ink prepared in above (a) was applied onto an electrolyte membrane 10 into the pattern as illustrated in FIGS. 12 to 15 by the following procedures, using the spray coater 50 provided with the pray gun 53 as illustrated in FIG. 8, so that an anode-catalyst layer 16 having a size of 9 cm×9 cm was formed at the center of the electrolyte membrane. The electrolyte membrane 10 used here was an electrolyte membrane (Nafion (registered trademark) 112 available from E.I. du Pont de Nemours and Company) cut in a size of 12 cm×12 cm. The moving speed of the spray gun 53 for application of the anode catalyst ink was set to 60 mm/sec, and the jetting pressure of the jet gas (nitrogen gas) was set to 0.15 MPa. The clearance between the tip end of the spray gun 53 and the electrolyte membrane 10 was set to 7 cm, and the surface temperature of the electrolyte membrane 10 was adjusted to 70° C.

A 12 cm×12 cm mask provided with a 9 cm×9 cm cut-out portion at its center was placed on one principal surface of the electrolyte membrane 10. In this state, the anode catalyst ink was sprayed from the spray gun 53 toward the cut-out portion, and the mask was finally removed, to form the anode catalyst layer 16. The procedures are described below in more details.

First, in a region (9 cm×3 cm) of the electrolyte membrane 10 to face the upstream of the fuel flow channel, the anode catalyst ink was applied. Specifically, while the spray gun 53 was moved linearly in the directions parallel to arrow X (the plus and minus X-axis directions), the anode catalyst ink was sprayed onto the electrolyte membrane 10, to form a belt-like coating 73a. The spray gun 53 was then moved in the direction indicated by arrow Y (in the Y-axis direction or the direction parallel to the principal surface of the electrolyte membrane 10), and repeated the same operation. Total three belt-like coatings 73a were formed side by side, as a group of coatings 73A of the first layer. At this time, they were formed such that the overlap between the belt-like coatings 73a adjacent to each other within the same layer (in the Y-axis direction) became 20% of the width of the coating 73a. The distance that the spray gun 53 moved linearly in the direction parallel to arrow X (in the X-axis direction) over the electrolyte membrane 10 was set to 11 cm, and a width 79 of one belt-like coating 73a was set to 10 mm.

Next, in a region (9 cm×6 cm) of the electrolyte membrane 10 to face the midstream and downstream of the fuel flow channel, the anode catalyst ink was applied next to the group of coatings 73A, to form belt-like coatings 74a. The belt-like coatings 74a were formed in the same manner as the belt-like coatings 73a, except that the distance that the spray gun 53 moved linearly in the X-axis direction over the electrolyte membrane 10 was changed to 8 cm. Total six belt-like coatings 74a were formed side by side as illustrated in FIG. 12, as a group of coatings 74A of the first layer.

In this manner, a group of coatings 75A of the first layer comprising the group of coatings 73A formed in the region to face the upstream of the fuel flow channel, and the group of coatings 74A formed in the region to face the midstream and downstream thereof was formed.

On the group of coatings 73A of the first layer, three belt-like coatings 73b whose longitudinal direction was in the X-axis direction were formed side by side in the Y-axis direction, in the same manner as in the first layer. A group of coatings 73B of the second layer was thus formed. At this time, the belt-like coating 73b was formed so as to overlap with two adjacent belt-like coatings 73a of the first layer, as illustrated in FIGS. 13 and 15. A width 78 of the overlap between the belt-like coatings 73a and 73b adjacent to each other in the stacking direction (in the plus Z-axis direction in FIG. 15) was set to 50% of the width of each of the belt-like coatings 73a and 73b.

Next, the anode catalyst ink was applied next to the group of coatings 73B of the second layer, in the region of the electrolyte membrane 10 to face the midstream and downstream of the fuel flow channel, to form belt-like coatings 74b. The belt-like coatings 74b were formed in the same manner as the belt-like coatings 73b, except that the distance that the spray gun 53 moved linearly in the X-axis direction over the electrolyte membrane 10 was changed to 8 cm. Total six belt-like coatings 74b were formed side by side as illustrated in FIG. 13, as a group of coatings 74B of the second layer.

In this manner, a group of coatings 75B of the second layer comprising the group of coatings 73B formed in the region to face the upstream of the fuel flow channel, and the group of coatings 74B formed in the region to face the midstream and downstream thereof was formed.

Thereafter, in the same manner as in the first and second layers, groups of coatings of the third to tenth layers were stacked as illustrated in FIG. 15. An anode catalyst layer was thus formed.

### (1-2) Production of Cathode Catalyst Layer

### (a) Preparation of Cathode Catalyst Ink

Conductive carbon particles supporting Pt fine particles (average particle diameter: 2 nm) were used as a cathode catalyst. The conductive carbon particles used here were the same as used for the anode catalyst. The mass ratio of the Pt fine particles to the total mass of the Pt fine particles and the conductive carbon particles was set to 46 mass %.

A cathode catalyst ink was prepared in the same manner as the anode catalyst ink, except that the above cathode catalyst was used in place of the anode catalyst, and the mass ratio of polymer electrolyte to the total solids was changed to 20 mass %.

### (b) Formation of Cathode Catalyst Layer

A cathode catalyst layer 18 having a size of 9 cm×9 cm was formed at the center of the electrolyte membrane in the same manner as the anode catalyst layer 16, except that the cathode catalyst ink prepared in above (a) was applied as illustrated in FIGS. 9 to 11 on the surface of the electrolyte membrane 10 opposite to the surface where the anode catalyst layer 16 was formed.

Specifically, while the spray gun 53 was being moved linearly in the X-axis direction, the cathode catalyst ink was sprayed onto the electrolyte membrane 10, thereby to form a belt-like coating 173a. A plurality of belt-like coatings 173a was formed side by side in the Y-axis direction, as a group of coatings 173A of the first layer. At this time, they were formed such that the overlap between the belt-like coatings 173a adjacent to each other in the Y-axis direction became 50% of the width of the coating 173a. The distance that the spray gun 53 moved in the X-axis direction over the electrolyte membrane 10 was set to 11 cm, and a width 179 of one belt-like coating 173a was set to 10 mm.

On the group of coatings 173A of the first layer, belt-like coatings 173b whose longitudinal direction was in the X-axis direction were formed side by side in the Y-axis direction in the same manner as in the first layer. A group of coatings 173B of the second layer was thus formed. At this time, the belt-like coating 173b was formed so as to overlap with two adjacent belt-like coatings 173a of the first layer, as illustrated in FIGS. 10 and 11. Of the overlap between the belt-like coatings 173a and 173b adjacent to each other in the stacking direction (the plus Z-axis direction in FIG. 11), a width 178 of the larger size portion was set to 90% of the width of each of the belt-like coatings 173a and 173b.

Thereafter, in the same manner as in the first and second layers, groups of coatings of the third to tenth layers were stacked as illustrated in FIG. 11. A cathode catalyst layer was thus formed. The catalyst amount per unit projected area in the cathode catalyst layer was 1.2 mg/cm².

### (2) Production of Anode Diffusion Layer

An anode diffusion layer 17 was produced as described below by forming a porous composite layer on a conductive porous substrate having been subjected to water-repellent treatment.

### (a) Water-Repellent Treatment of Conductive Porous Substrate

The conductive porous substrate used here was carbon paper (TGP-H090 available from Toray Industries Inc.).

The conductive porous substrate was immersed for 1 minute in a polytetrafluoroethylene resin (PTFE) dispersion (an aqueous solution prepared by diluting D-1E available from Daikin Industries, Ltd. with ion-exchange water, solid concentration: 7 mass %). The conductive porous substrate after immersion was dried at room temperature in the air for 3 hours. Thereafter, the conductive porous substrate after drying was heated at 360° C. in an inert gas (N₂) for 1 hour to remove the surfactant contained in the PTFE dispersion.

In this manner, water-repellent treatment was applied to the conductive porous substrate. The content of PTFE in the conductive porous substrate after water-repellent treatment was 12.5 mass %.

### (b) Formation of Porous Composite Layer

Carbon black (Vulcan (registered trademark) XC-72R available from CABOT Corporation) serving as a conductive carbon material was added to an aqueous solution containing a surfactant (Triton (registered trademark) X-100 available from Sigma-Aldrich Co. LLC.), and highly dispersed therein with a kneader-disperser (HIVIS MIX available from PRIMIX Corporation). To the resultant dispersion, a PTFE dispersion (D-1E available from Daikin Industries, Ltd.) serving as a water-repellent resin material was added and stirred for 3 hours with a disper, to prepare a paste for forming a porous composite layer.

The paste for forming a porous composite layer was uniformly applied with a doctor blade coater onto one surface of the conductive porous substrate having been subjected to water-repellent treatment obtained in above (a), and dried at room temperature in the air for 8 hours. The resultant dry material was baked at 360° C. in an inert gas (N₂) for 1 hour to remove the surfactant, so that a porous composite layer was formed. The PTFE content in the porous composite layer was 40 mass %, and the amount of the porous composite layer per unit projected area was 2.4 mg/cm².

### (3) Production of Cathode Diffusion Layer

A cathode diffusion layer 19 was produced in the same manner as the anode diffusion layer 17, by forming a porous composite layer on a conductive porous substrate having been subjected to water-repellent treatment, except that a PTFE dispersion with solid concentration of 15 wt % (an aqueous solution prepared by diluting 60 mass % PTFE dispersion available from Sigma-Aldrich Co. LLC. with ion-exchange water) was used as the PTFE dispersion used for water-repellent treatment of the conductive porous substrate.

The PTFE content in the conductive porous substrate having been subjected to water-repellent treatment was 23.5 mass %. The applied amount of the paste for forming a porous composite layer was adjusted by changing the setting gap of the doctor blade. In the resultant cathode diffusion layer 19, the amount of the porous composite layer per unit projected area was 1.8 mg/cm².

### (4) Production of Membrane-Electrode Assembly

The anode diffusion layer 17 and the cathode diffusion layer 19 obtained in above (2) and (3) were each cut in the size of 9 cm×9 cm. The anode diffusion layer 17 and the cathode diffusion layer 19 were stacked on the anode catalyst layer 16 and the cathode catalyst layer 18 of the CCM obtained in above (1), respectively, so as to be in contact therewith. The resultant stack was hot-pressed at 130° C. and 4 MPa for 3 minutes. By doing this, the anode catalyst layer 16 and the anode diffusion layer 17 were bonded to each other, and the cathode catalyst layer 17 and the cathode diffusion layer 19 were bonded to each other. In this manner, a membrane electrode assembly (MEA) 13 comprising an anode 11 including the anode catalyst layer 16 and the anode diffusion layer 17, a cathode 11 including the cathode catalyst layer 18 and the cathode diffusion layer 19, and the electrolyte membrane 10 interposed therebetween was obtained.

### (5) Fabrication of Fuel Cell

An anode-side gasket 22 and a cathode-side gasket 23 were disposed around the anode 11 and cathode 12 of the MEA 13 obtained in above (4), respectively, so as to sandwich the electrolyte membrane 10. The gaskets 22 and 23 used here were three-layer structures each including a polyetherimide intermediate layer, and silicone rubber layers disposed on both sides thereof.

The MEA 13 fitted with the gaskets 22 and 23 were sandwiched between anode-side and cathode-side separators 14 and 15, current collector plates 24 and 25, sheet heaters 26 and 27, insulator plates 28 and 29, and end plates 30 and 31, each of which had outer dimensions of 15 cm×15 cm, and they were secured by clamping rods. The clamping pressure was set to 12 kgf/cm² (≈1.2 MPa) per area of the separators. A direct oxidation fuel cell (Cell A) was thus fabricated.

The separators 14 and 15 used here were resin-impregnated graphite separators each having a thickness of 4 mm (G347B available from TOKAI CARBON CO., LTD.). Each of the separators had been provided in advance with a serpentine flow channel having a width of 1.5 mm and a depth of 1 mm. The current collector plates 24 and 25 used here were gold-plated stainless steel plates. The sheet heaters 26 and 27 used here were SEMICON heaters (available from SAKAGUCHI E.H. VOC CORP.).

### Examples 2 to 10

In (b) of (1-1) of Example 1, in the region to face the midstream and downstream of the fuel flow channel, six belt-like coatings were formed in the odd-number-th layers, and five belt-like coatings were formed in the even-number-th layers. In the region to face the midstream and downstream of the fuel flow channel, in the even-number-th layers, the distance that the spray gun moved linearly in the direction parallel to arrow X over the electrolyte membrane was set to 6 cm. A direct oxidation fuel cell (Cell B) of Example 2 was fabricated in the same manner as in Example 1, except the above.

Direct oxidation fuel cells (Cells C, D and F to J) of Examples 3, 4 and 6 to 10 were fabricated in the same manner as in Example 1, except that in (b) of (1-1) of Example 1, the conditions for forming belt-like coatings were changed as shown in Table 1.

A direct oxidation fuel cell (Cell E) of Example 5 was fabricated in the same manner as in Example 1, except that in (b) of (1-1) of Example 1, the conditions for forming belt-like coatings were changed as shown in Table 1, and the jetting pressure of the jet gas was changed to 0.10 MPa.

### Comparative Examples 1 to 3

A direct oxidation fuel cell (Comparative Cell 1) of Comparative Example 1 was fabricated in the same manner as in Example 1, except that in forming belt-like coatings in (b) of (1-1) of Example 1, the belt-like coatings were formed similarly to those of the cathode catalyst layer in (b) of (1-2) of Example 1, as illustrated in FIGS. 9 to 11.

Direct oxidation fuel cells (Comparative Cells 2 and 3) of Comparative Examples 2 and 3 were fabricated in the same manner as in Comparative Example 1, except that in forming an anode catalyst layer of Comparative Example 1, the conditions for forming belt-like coatings were changed as shown in Table 1.

### Example 11

An anode catalyst layer was formed in the same manner as in Example 1, except that in forming belt-like coatings in (b) of (1-1) of Example 1, the belt-like coatings were formed similarly to those of the cathode catalyst layer in (b) of (1-2) of Example 1, as illustrated in FIGS. 9 to 11. The amount of anode catalyst per unit projected area in the anode catalyst layer was 3.2 mg/cm².

A cathode catalyst layer was formed in the same manner as in Example 1, except that in forming belt-like coatings in (b) of (1-2) of Example 1, the belt-like coatings were formed similarly to those of the anode catalyst layer in (b) of (1-1) of Example 1, as illustrated in FIGS. 12 to 15.

In this manner, the anode catalyst layer was formed on one surface of an electrolyte membrane, and the cathode catalyst layer was formed on the other surface thereof, to produce a CCM. A direct oxidation fuel cell (Cell K) was fabricated in the same manner as in Example 1, except that the CCM thus produced was used.

### Examples 12 to 20

In the formation of a cathode catalyst layer, in forming belt-like coatings in the region to face the midstream and downstream of the fuel flow channel, six belt-like coatings were formed in the odd-number-th layers, and five belt-like coatings were formed in the even-number-th layers. In the region to face the midstream and downstream of the fuel flow channel, in the even-number-th layers, the distance that the spray gun moved linearly in the direction parallel to arrow X over the electrolyte membrane was set to 6 cm. A direct oxidation fuel cell (Cell L) of Example 12 was fabricated in the same manner as in Example 11, except the above.

Direct oxidation fuel cells (Cells M, N and P to T) of Examples 13, 14 and 16 to 20 were fabricated in the same manner as in Example 11, except that in the formation of a cathode catalyst layer, the conditions for forming belt-like coatings were changed as shown in Table 2.

A direct oxidation fuel cell (Cell O) of Example 15 was fabricated in the same manner as in Example 11, except that in the formation of a cathode catalyst layer, the conditions for forming belt-like coatings were changed as shown in Table 2, and the jetting pressure of the jet gas was changed to 0.10 MPa.

### Comparative Examples 4 and 5

In forming belt-like coatings in the formation of a cathode catalyst layer, the belt-like coatings were formed similarly to those of the anode catalyst layer of Example 11, as illustrated in FIGS. 9 to 11. At this time, the number of stacked coatings was changed as shown in Table 2. Direct oxidation fuel cells (Comparative Cells 4 and 5) of Comparative Examples 4 and 5 were fabricated in the same manner as in Example 11, except the above.

The conditions for forming anode and cathode catalyst layers of Examples and Comparative Examples are shown in Tables 1 and 2.

TABLE 1

| | Anode | | | | | | | | | | | | | |
|---|---|---|---|---|---|---|---|---|---|---|---|---|---|---|
| | | Number of belt-like | | Moving distance of | | | | | | | | | | |
| | | coatings | | spray gun (cm) | | | | | Cathode | | | | | |
| | Width | | Region to | | Region to | Overlap | | | Width | | Overlap | | | |
| | of | | face | | face | between | | | of | Moving | between | | | |
| | belt- | Region to | midstream | Region to | midstream | belt-like | | Number | belt- | distance | belt-like | | Number | |
| | like | face | and | face | and | coatings (%) | | of | like | of spray | coatings (%) | | of | Catalyst |
| | coating | upstream | downstream | upstream | downstream | Y- | Z- | stacked | coating | gun | Y- | Z- | stacked | amount |
| | (mm) | portion | portions | portion | portions | axis | axis | coatings | (mm) | (cm) | axis | axis | coatings | (g/cm²) |
| Cell A | 10 | 3 | 6 | 11 | 8 | 20 | 50 | 10 | 10 | 11 | 50 | 90 | 10 | 1.2 |
| Cell B | 10 | 3 | 6 (odd) | 11 | 8 (odd) | 20 | 50 | 10 | | | | | | |
| | | | 5 (even) | | 6 (even) | | | | | | | | | |
| Cell C | 10 | 3 | 6 (odd) | 11 | 8 (odd) | 20 | 50 | 10 | | | | | | |
| | | | 4 (even) | | 4 (even) | | | | | | | | | |
| Cell D | 15 | 2 | 4 | 11 | 8 (odd) | 17 | 67 | 10 | | | | | | |
| | | | | | 7 (even) | | | | | | | | | |
| Cell E | 10 | 3 | 6 | 11 | 8 | 20 | 50 | 7 | | | | | | |
| Cell F | 10 | 3 | 6 | 11 | 8 (odd) | 20 | 75 | 10 | | | | | | |
| | | | | | 8.5 (even) | | | | | | | | | |
| Cell G | 10 | 3 | 6 (odd) | 11 | 8 (odd) | 20 | 75 | 10 | | | | | | |
| | | | 4 (even) | | 3.5 (even) | | | | | | | | | |
| Cell H | 10 | 3 | 6 | 11 | 8 | 20 | 50 | 3 | | | | | | |
| Cell I | 10 | 3 | 6 (odd) | 11 | 8 (odd) | 20 | 50 | 14 | | | | | | |
| | | | 4 (even) | | 4 (even) | | | | | | | | | |
| Cell J | 10 | 3 (odd) | 6 (odd) | 11 (odd) | 8 (odd) | 20 | 50 | 10 | | | | | | |
| | | 1.5 (even) | 5 (even) | 6 (even) | 6 (even) | | | | | | | | | |

| | | | | | | | | | | | |
|---|---|---|---|---|---|---|---|---|---|---|---|
| Com. | 10 | 11 | 50 | 90 | 10 | 10 | 11 | 50 | 90 | 10 | 1.2 |
| Cell 1 | | | | | | | | | | | |
| Com. | 10 | 11 | 50 | 90 | 3 | | | | | | |
| Cell 2 | | | | | | | | | | | |
| Com. | 10 | 11 | 50 | 90 | 14 | | | | | | |
| Cell 3 | | | | | | | | | | | |

(odd): the odd-number-th layer;
(even): the even-number-th layer

TABLE 2

| | | | | | | | Cathode | | | | | | | |
|---|---|---|---|---|---|---|---|---|---|---|---|---|---|---|
| | | | | | | | | Number of belt-like | | Moving distance of | | | | |
| | Anode | | | | | | | coatings | | spray gun (cm) | | | | |
| | Width | | Overlap | | | | Width | | Region to | | Region to | Overlap | | |
| | of | Moving | between | | | | of | | face | | face | between | | |
| | belt- | distance | belt-like | | Number | | belt- | Region to | midstream | Region to | midstream | belt-like | | Number |
| | like | of spray | coatings (%) | | of | Catalyst | like | face | and | face | and | coatings (%) | | of |
| | coating | gun | Y- | Z- | stacked | amount | coating | upstream | downstream | upstream | downstream | Y- | | stacked |
| | (mm) | (cm) | axis | axis | coatings | (g/cm²) | (mm) | portion | portions | portion | portions | axis | Z-axis | coatings |
| Cell K | 10 | 11 | 50 | 90 | 10 | 3.2 | 10 | 3 | 6 | 11 | 8 | 20 | 50 | 10 |
| Cell L | | | | | | | 10 | 3 | 6 (odd) | 11 | 8 (odd) | 20 | 50 | 10 |
| | | | | | | | | | 5 (even) | | 6 (even) | | | |
| Cell M | | | | | | | 10 | 3 | 6 (odd) | 11 | 8 (odd) | 20 | 50 | 10 |
| | | | | | | | | | 4 (even) | | 4 (even) | | | |
| Cell N | | | | | | | 15 | 2 | 4 | 11 | 8 (odd) | 17 | 67 | 10 |
| | | | | | | | | | | | 7 (even) | | | |
| Cell O | | | | | | | 10 | 3 | 6 | 11 | 8 | 20 | 50 | 8 |
| Cell P | | | | | | | 10 | 3 | 6 | 11 | 8 (odd) | 20 | 75 | 10 |
| | | | | | | | | | | | 8.5 (even) | | | |
| Cell Q | | | | | | | 10 | 3 | 6 (odd) | 11 | 8 (odd) | 20 | 75 | 10 |
| | | | | | | | | | 4 (even) | | 3.5 (even) | | | |
| Cell R | | | | | | | 10 | 3 | 6 | 11 | 8 | 20 | 50 | 3 |
| Cell S | | | | | | | 10 | 3 | 6 (odd) | 11 | 8 (odd) | 20 | 50 | 14 |
| | | | | | | | | | 4 (even) | | 4 (even) | | | |
| Cell T | | | | | | | 10 | 3 (odd) | 6 (odd) | 11 (odd) | 8 (odd) | 20 | 50 | 10 |
| | | | | | | | | 1.5 (even) | 5 (even) | 6 (even) | 6 (even) | | | |

| | | | | | | | | | | | |
|---|---|---|---|---|---|---|---|---|---|---|---|
| Com. | 10 | 11 | 50 | 90 | 10 | 3.2 | 10 | 11 | 50 | 90 | 6 |
| Cell 4 | | | | | | | | | | | |
| Com. | | | | | | | 10 | 11 | 50 | 90 | 18 |
| Cell 5 | | | | | | | | | | | |

(odd): the odd-number-th layer;
(even): the even-number-th layer

### [Evaluation]

### (A) Anode Catalyst Layer

Experimental anode catalyst layers were formed under the same conditions as those of Examples 1 to 10 and Comparative Examples 1 to 3, and evaluated as follows.

(1) Catalyst amounts C₁, C₂ₐ, C_{2b} and C_{2c}

The catalyst amounts C₁, C₂ₐ, C_{2b} and C_{2c} (g/cm²) per unit projected area in the center portion and peripheral portion of the anode catalyst layer were measured by the following method. Here, C₁ is a catalyst amount in the center portion, C₂ₐ is a catalyst amount in the region facing the upstream of the fuel flow channel within the peripheral portion, C_{2b} is a catalyst amount in the region facing the midstream of the fuel flow channel within the peripheral portion, and C_{2c} is a catalyst amount in the region facing the downstream of the fuel flow channel within the peripheral portion.

An anode catalyst layer was formed on a PTFE porous membrane (TEMISH S-NTF1133 available from Nitto Denko Corporation) by forming belt-like coatings as shown in FIG. 10, in the same manner as those of the anode catalyst layer of Example 11. At this time, several anode catalyst layers having different anode catalyst amounts per unit projected area within the range of 0.5 to 5.0 mg/cm² were formed by changing the number of stacked coatings. These anode catalyst layers were used as standard samples for measurement, to analyze an in-plane distribution of Pt intensity in the catalyst layer, using a micro X-ray fluorescence spectrometer. Then, a calibration curve was drawn on the basis of the relationship between the anode catalyst amount per unit projected area and the Pt intensity.

Next, on the PTFE porous membranes as above, anode catalyst layers were formed under the same conditions as those in Examples 1 to 10 and Comparative Examples 1 to 3, and the in-plane distributions of Pt intensity in the catalyst layers were analyzed in the same manner as above. On the basis of the analysis results here, the calibration curve above, and the Pt:Ru mass ratio, the catalyst amounts C₁, C₂ₐ, C_{2b} and C_{2c (g/cm}²) were calculated.

### (2) Ratio of Projected Area of Peripheral Portion

On the basis of the analysis data of the in-plane distributions of Pt intensity obtained in (1) above in the anode catalyst layers formed under the same conditions as those in Examples 1 to 10, the projected areas A₁, A₂ₐ, A_{2b} and A_{2c} of the center and peripheral portions of each anode catalyst layer were determined. Here, A₁ is a projected area of the center portion, A₂ₐ is a projected area of the region facing the upstream of the fuel flow channel within the peripheral portion, A_{2b} is a projected area of the region facing the midstream of the fuel flow channel within the peripheral portion, and A_{2c} is a projected area of the region facing the downstream of the fuel flow channel within the peripheral portion.

From the values of the projected area obtained above, the ratio (A_{2b}+A_{2c})/(A₁+A₂ₐ+A_{2b}+A_{2c}) of the projected area of the regions facing the midstream and downstream of the fuel flow channel within the peripheral portion to the projected area of the entire anode catalyst layer was calculated.

### (B) Cathode Catalyst Layer

### (1) Catalyst Amounts C₁, C₂ₐ, C_{2b} and C_{2c}

A cathode catalyst layer was formed instead of the anode catalyst layer of Example 11, by forming belt-like coatings as shown in FIG. 10, in the same manner as those of the cathode catalyst layer of Example 1. At this time, several cathode catalyst layers having different cathode catalyst amounts per unit projected area within the range of 0.1 to 2.5 mg/cm² were formed by changing the number of stacked coatings. A calibration curve was drawn in the same manner as in the above (1) in Evaluation (A) above, except that these cathode catalyst layers were used in place of the anode catalyst layers.

The in-plane distributions of Pt intensity in the catalyst layers were analyzed in the same manner as in the above (1) in Evaluation (A) above, except that the cathode catalyst layers formed under the same conditions as those in Examples 11 to 20 and Comparative Examples 4 and 5 were used in place of the anode catalyst layers. On the basis of the analysis results here and the calibration curve above, the catalyst amounts C₁, C₂ₐ, C_{2b} and C_{2c} (g/cm²) per unit projected area of the cathode catalyst layer were calculated.

### (2) Ratio of Projected Area of Peripheral Portion

The analysis data of the in-plane distributions of Pt intensity obtained in (1) of (B) above in the cathode catalyst layers formed under the same conditions as those in Examples 11 to 20 were used in place of the analysis data of the in-plane distributions of Pt intensity in the anode catalyst layers. In the same manner as in (2) of (A), except the above, the projected areas A₁, A₂ₐ, A_{2b} and A_{2c} in the center and peripheral portions of each cathode catalyst layer were determined, and the ratio (A_{2b}+A_{2c})/(A₁A₂ₐ+A_{2b}+A_{2c}) between the projected areas was calculated.

### (C) Power Generation Characteristics of Cell

Direct oxidation fuel cells fabricated in Examples and Comparative Examples were used for evaluating the power generation characteristics.

The cells were operated continuously at a constant current density of 150 mA/cm², while an aqueous methanol solution (methanol concentration: 2 mol/L) was supplied as a fuel to the anode at a flow rate of 1.26 ml/min, and air was supplied as an oxidant to the cathode at a flow rate of 0.44 L/min. The operating cell temperature was set at 70° C.

The value of power density was calculated from the value of voltage measured at 4 hours after the start of power generation. The obtained value was regarded as an initial power density. Thereafter, the value of power density was calculated from the value of voltage measured at 5000 hours after the start of power generation.

The ratio of the power density after 5000 hours to the initial power density was calculated as a percentage, which was used as a power density retention rate. It should be noted that the power density retention rate can be an index of the cell durability.

The results of the above evaluation are shown in Tables 3 and 4. The overlapping percentages (%) between belt-like coatings in the Y-axis and Z-axis directions in the anode and cathode catalyst layers are also shown in Tables 3 and 4.

TABLE 3

| | | | | | | | | | | | Power generation | |
|---|---|---|---|---|---|---|---|---|---|---|---|---|
| | | | | | | | | | | | characteristics of | |
| | Anode | | | | | | | | | | cell | |
| | | | | | | | | | Overlap between | | | Power |
| | | | | | | | | | belt-like | | Initial | density |
| | | | | | | | | | coatings | | power | retention |
| | C₁ | C₂ₐ | | C_{2b} | | C_{2c} | | (A_{2b} + A_{2c})/ | (%) | | density | rate |
| | (g/cm²) | (g/cm²) | C₂ₐ/C₁ | (g/cm²) | C_{2b}/C₁ | (g/cm²) | C_{2c}/C₁ | (A₁ + A₂ₐ + A_{2b} + A_{2c}) | Y-axis | Z-axis | (mW/cm²) | (%) |
| Cell A | 3.2 | 3.2 | 1 | 2.5 | 0.78 | 2.5 | 0.78 | 0.12 | 20 | 50 | 71 | 95 |
| Cell B | 3.2 | 3.2 | 1 | 1.7 | 0.53 | 1.7 | 0.53 | 0.33 | 20 | 50 | 70 | 96 |
| Cell C | 3.2 | 3.2 | 1 | 1.5 | 0.47 | 1.5 | 0.47 | 0.49 | 20 | 50 | 68 | 97 |
| Cell D | 3.2 | 3.2 | 1 | 2.1 | 0.66 | 2.1 | 0.66 | 0.23 | 17 | 67 | 70 | 98 |
| Cell E | 3.2 | 3.2 | 1 | 2.5 | 0.78 | 1.8 | 0.56 | 0.12 | 20 | 50 | 71 | 98 |
| Cell F | 3.2 | 3.2 | 1 | 2.7 | 0.84 | 2.7 | 0.84 | 0.06 | 20 | 75 | 71 | 91 |
| Cell G | 3.2 | 3.2 | 1 | 0.6 | 0.19 | 0.6 | 0.19 | 0.53 | 20 | 75 | 67 | 88 |
| Cell H | 0.9 | 0.9 | 1 | 0.7 | 0.78 | 0.7 | 0.78 | 0.12 | 20 | 50 | 62 | 87 |
| Cell I | 4.5 | 4.5 | 1 | 2.1 | 0.47 | 2.1 | 0.47 | 0.49 | 20 | 50 | 72 | 94 |
| Cell J | 3.2 | 1.7 | 0.53 | 1.7 | 0.53 | 1.7 | 0.53 | 0.33 | 20 | 50 | 65 | 89 |
| Com. | 3.2 | 3.2 | 1 | 3.2 | 1 | 3.2 | 1 | — | 50 | 90 | 69 | 78 |
| Cell 1 | | | | | | | | | | | | |
| Com. | 0.9 | 0.9 | 1 | 0.9 | 1 | 0.9 | 1 | — | 50 | 90 | 59 | 73 |
| Cell 2 | | | | | | | | | | | | |
| Com. | 4.5 | 4.5 | 1 | 4.5 | 1 | 4.5 | 1 | — | 50 | 90 | 72 | 76 |
| Cell 3 | | | | | | | | | | | | |

TABLE 4

| | | | | | | | | | | | Power generation | |
|---|---|---|---|---|---|---|---|---|---|---|---|---|
| | | | | | | | | | | | characteristics of | |
| | Cathode | | | | | | | | | | cell | |
| | | | | | | | | | Overlap between | | | Power |
| | | | | | | | | | belt-like | | Initial | density |
| | | | | | | | | | coatings | | power | retention |
| | C₁ | C₂ₐ | | C_{2b} | | C_{2c} | | (A_{2b} + A_{2c})/ | (%) | | density | rate |
| | (g/cm²) | (g/cm²) | C₂ₐ/C₁ | (g/cm²) | C_{2b}/C₁ | (g/cm²) | C_{2c}/C₁ | (A₁ + A₂ₐ + A_{2b} + A_{2c}) | Y-axis | Z-axis | (mW/cm²) | (%) |
| Cell K | 1.2 | 1.2 | 1 | 0.9 | 0.75 | 0.9 | 0.75 | 0.12 | 20 | 50 | 72 | 97 |
| Cell L | 1.2 | 1.2 | 1 | 0.7 | 0.58 | 0.7 | 0.58 | 0.33 | 20 | 50 | 70 | 96 |
| Cell M | 1.2 | 1.2 | 1 | 0.6 | 0.50 | 0.6 | 0.50 | 0.49 | 20 | 50 | 67 | 95 |
| Cell N | 1.2 | 1.2 | 1 | 0.8 | 0.67 | 0.8 | 0.67 | 0.23 | 17 | 67 | 71 | 97 |
| Cell O | 1.2 | 1.2 | 1 | 0.9 | 0.75 | 0.7 | 0.58 | 0.12 | 20 | 50 | 72 | 98 |
| Cell P | 1.2 | 1.2 | 1 | 1.0 | 0.83 | 1.0 | 0.83 | 0.06 | 20 | 75 | 72 | 94 |
| Cell Q | 1.2 | 1.2 | 1 | 0.2 | 0.17 | 0.2 | 0.17 | 0.53 | 20 | 75 | 63 | 86 |
| Cell R | 0.7 | 0.7 | 1 | 0.5 | 0.71 | 0.5 | 0.71 | 0.12 | 20 | 50 | 60 | 84 |
| Cell S | 2.2 | 2.2 | 1 | 1.0 | 0.45 | 1.0 | 0.45 | 0.49 | 20 | 50 | 75 | 94 |
| Cell T | 1.2 | 0.7 | 0.58 | 0.7 | 0.58 | 0.7 | 0.58 | 0.33 | 20 | 50 | 62 | 88 |
| Com. | 0.7 | 0.7 | 1 | 0.7 | 1 | 0.7 | 1 | — | 50 | 90 | 58 | 78 |
| Cell 4 | | | | | | | | | | | | |
| Com. | 2.2 | 2.2 | 1 | 2.2 | 1 | 2.2 | 1 | — | 50 | 90 | 74 | 79 |
| Cell 5 | | | | | | | | | | | | |

As shown in Tables 3 and 4, Cells A to T exhibited high power density retention rates even though the catalyst amount in the regions facing the midstream and downstream of the fuel flow channel within the peripheral portion of the catalyst layer was smaller than that in the center portion.

In contrast, Comparative Cells 1 to 5 exhibited considerably low power density retention rates.

The methanol concentration decreases in the regions facing the midstream and downstream of the fuel flow channel. Moreover, the volume of pores in the peripheral portion of the catalyst layer tends to decrease in the process of heat-bonding the catalyst layer to the diffusion layer by hot-pressing or the like or of applying pressure to the catalyst layer for cell fabrication. Since the pores in the peripheral portion serve as the distribution paths of fuel or oxidant, a decrease in pore volume of the peripheral portion tends to slow the diffusion of the fuel or oxidant.

In Comparative Cells 1 to 5, the catalyst amounts in the regions facing the midstream and downstream of the fuel flow channel within the peripheral portion of the catalyst layer were almost the same as that in the center portion. Presumably because of this, the pore volume was decreased in cell fabrication, and the diffusibility of the fuel or oxidant in the thickness direction of the catalyst layer was degraded.

In contrast, in the cells of Examples, the catalyst amounts in the regions facing the midstream and downstream of the fuel flow channel within the peripheral portion of the catalyst layer were smaller than that in the center portion. Presumably because of this, the decrease in the pore volume of the peripheral portion was suppressed, and the diffusibility of the fuel and oxidant in the thickness direction of the catalyst layer was improved. Presumably as a result, excellent power density retention rates were obtained. Among the cells of Examples, Cells A to E and Cells K to O exhibited remarkably improved power density retention rates and initial power densities.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The DOFC of the present invention is excellent in catalyst utilization efficiency and thus has excellent power generation characteristics. Furthermore, in the process of producing a CCM used for the DOFC, the loss of catalyst can be reduced, leading to a reduction in production cost of the fuel cell. Therefore, the DOFC of the present invention is useful as, for example, a power source for portable small electronic devices, such as cellular phones, notebook personal computers, and digital still cameras, or a portable power source to be used as a replacement for an engine generator, in a construction sites, for outdoor leisure use, in case of emergency and disaster, in medical situations, or in filming locations. Furthermore, the DOFC of the present invention is suitably applicable also as a power source for electric scooters, automobiles, and the like.

### REFERENCE SIGNS LIST

1 Direct oxidation fuel cell
10 Electrolyte membrane
11 Anode
12 Cathode
13 Membrane electrode assembly (MEA)
14 Anode-side separator
15 Cathode-side separator
16 Anode catalyst layer
17 Anode diffusion layer
18 Cathode catalyst layer
19 Cathode diffusion layer
20 Fuel flow channel
21 Oxidant flow channel
22 Anode-side gasket
23 Cathode-side gasket
24, 25 Current collector plate
26, 27 Sheet heater
28, 29 Insulator plate
30, 31 End plate
40, 42 Center portion
41, 43 Peripheral portion
41a, 43a Region facing the upstream of flow channel within peripheral portion
41b, 43b Region facing the midstream of flow channel within peripheral portion
41c, 43c Region facing the downstream of flow channel within peripheral portion
50 Spray coater
51 Tank
52 Catalyst ink
53 Spray gun
54 Stirrer
55 Open/close valve
56 Supply pipe
57 Gas pressure regulator
58 Gas flow regulator
59 Spray gun unit
60 Actuator
61 Area to be coated
62 Mask
63 Heater
173a, 173b, 73a, 73b, 74a, 74b Belt-like coating
173A, 173B, 73A, 74A, 74B, 75A, 75B Group of belt-like coatings
76 End of belt-like coating (outermost end of belt-like coatings) in the longitudinal direction
77 End of belt-like coating in the lateral direction
78, 178 Width of overlap between adjacent belt-like coatings in the Z-axis direction
79, 179 Width of belt-like coating

1. A direct oxidation fuel cell having at least one unit cell, the unit cell comprising: a membrane-electrode assembly including an anode, a cathode, and an electrolyte membrane interposed between the anode and the cathode; an anode-side separator being in contact with the anode; and a cathode-side separator being in contact with the cathode,
the anode-side separator having a supply port for supplying fuel therethrough, and a fuel flow channel extending from the supply port,
the cathode-side separator having a supply port for supplying oxidant therethrough, and an oxidant flow channel extending from the supply port,
the fuel flow channel and the oxidant flow channel each having an upstream portion continued from the supply port, a midstream portion continued from the upstream portion, and a downstream portion continued from the midstream portion,
the anode including an anode catalyst layer disposed on one principal surface of the electrolyte membrane, and an anode diffusion layer being laminated on the anode catalyst layer and being in contact with the anode-side separator,
the cathode including a cathode catalyst layer disposed on the other principal surface of the electrolyte membrane, and a cathode diffusion layer being laminated on the cathode catalyst layer and being in contact with the cathode-side separator,
the anode catalyst layer and the cathode catalyst layer each including a catalyst and a polymer electrolyte,
the anode catalyst layer facing the upstream portion, the midstream portion, and the downstream portion of the fuel flow channel,
the cathode catalyst layer facing the upstream portion, the midstream portion, and the downstream portion of the oxidant flow channel,
at least one of the anode catalyst layer and the cathode catalyst layer having a center portion and a peripheral portion surrounding the center portion, and
a catalyst amount C_{2b} per unit projected area of a region facing the midstream portion within the peripheral portion and a catalyst amount C_{2c} per unit projected area of a region facing the downstream portion within the peripheral portion each being smaller than a catalyst amount C₁ per unit projected area of the center portion.

2. The direct oxidation fuel cell according to claim 1, wherein ratios C_{2b}/C₁ and C_{2c}/C₁ of the catalyst amount C_{2b} and the catalyst amount C_{2c} to the catalyst amount C₁ are each 0.2 or more and 0.8 or less.

3. The direct oxidation fuel cell according to claim 1, wherein a ratio C₂ₐ/C₁ of a catalyst amount C₂ₐ per unit projected area of a region facing the upstream portion within the peripheral portion to the catalyst amount C₁ is 0.95 or more and 1.05 or less.

4. The direct oxidation fuel cell according to claim 1, wherein the catalyst amount C₂ₐ per unit projected area of a region facing the upstream portion within the peripheral portion, the catalyst amount C_{2b}, and the catalyst amount C_{2c} satisfy the following relationship:
C₂ₐ>C_{2b}≧C_{2c}.

5. The direct oxidation fuel cell according to claim 1, wherein a ratio of a total projected area of the regions facing the midstream portion and the downstream portion within the peripheral portion to a total projected area of the center portion and the peripheral portion is 0.1 or more and 0.51 or less.

6. The direct oxidation fuel cell according to claim 1, wherein:
the anode catalyst layer has the center portion and the peripheral portion, and includes electrically conductive carbon particles, an anode catalyst supported on the conductive carbon particles, and a polymer electrolyte; and
the catalyst amount C₁ is 1 mg/cm² or more and 4 mg/cm² or less.

7. The direct oxidation fuel cell according to claim 1, wherein:
the cathode catalyst layer has the center portion and the peripheral portion, and includes electrically conductive carbon particles, a cathode catalyst supported on the conductive carbon particles, and a polymer electrolyte; and
the catalyst amount C₁ is 0.8 mg/cm² or more and 2 mg/cm² or less.

8-10. (canceled)
